(19) United States
(12) Patent Application Publication
(10) Pub. No.: US 2011/0236163 A1
(43) Pub. Date: Sep. 29, 2011

(54) BULK TRANSFER OF STORAGE DEVICES USING MANUAL LOADING

(76) Inventors: Marc Lesueur Smith, Sterling, MA (US); Edward Garcia, Holbrook, MA (US); Brian S. Merrow, Harvard, MA (US); Evgeny Polyakov, Brookline, MA (US); Eric L. Truebenbach, Sudbury, MA (US)

(21) Appl. No.: 13/053,651

(22) Filed: Mar. 22, 2011

Related U.S. Application Data
(60) Provisional application No. 61/316,667, filed on Mar. 23, 2010.

(51) Int. Cl. B65G 37/00; B65G 35/00; B65G 17/12; B65G 11/00; B25J 11/00

(52) U.S. Cl. 414/222.01; 198/618; 198/620; 198/801; 198/610; 193/2 R

(57) ABSTRACT

A storage device transfer station includes a first slot, a second slot, and a conveyor assembly. The conveyor assembly is configured to receive and support a plurality of storage devices such that the storage devices are vertically stacked and in spaced relation to each other. The conveyor assembly is operable to convey the storage devices between the first slot and the second slot.

### CROSS-REFERENCE TO RELATED APPLICATION

This patent application claims priority to U.S. Provisional Application No. 61/316,667, which was filed on Mar. 23, 2010. U.S. Provisional Application No. 61/316,667 is hereby incorporated by reference into this patent application as if set forth herein in full.

### TECHNICAL FIELD

This disclosure relates to bulk transfer of storage devices to and from storage device testing systems and transfer stations for storage device testing systems.

### BACKGROUND

Storage device manufacturers typically test manufactured storage devices for compliance with a collection of requirements. Test equipment and techniques exist for testing large numbers of storage devices serially or in parallel. Manufacturers tend to test large numbers of storage devices simultaneously in batches. Storage device testing systems typically include one or more racks having multiple test slots that receive storage devices for testing.

Current storage device testing systems use an operator, a robotic arm, or a conveyer belt to individually feed storage devices to a transfer location for loading into the testing system for testing. Other current storage device testers use a tote or a mobile tote to load or unload multiple storage devices to a transfer location at the same time. A robotic arm of the testing system retrieves the storage devices individually or in small batches from the transfer location and loads them in test slots for testing.

### SUMMARY

In general, this disclosure relates to bulk transfer of storage devices to and from storage device testing systems and transfer stations for storage device testing systems.

In one aspect, a storage device transfer station includes a first location, a second location, and a conveyor assembly. The conveyor assembly is configured to receive and support a plurality of storage devices such that the storage devices are vertically stacked (e.g., within a column) and in spaced relation to each other. The conveyor assembly is operable to convey the storage devices between the first location and the second location.

In another aspect, a storage device testing system includes one or more test racks, a plurality of test slots supported by the test racks, a storage device transfer station, and automated machinery configured to transfer storage devices between the storage device transfer station and the test slots. Each test slot is configured to receive a storage device for testing. The storage device transfer station includes a first location, a second location, and a conveyor assembly. The conveyor assembly is configured to receive and support a plurality of storage devices such that the plurality of storage devices are vertically stacked and in spaced relation to each other. The conveyor assembly is operable to convey the plurality of storage devices between the first location and the second location.

In a further aspect, a storage device testing system includes one or more test racks, a plurality of test slots supported by the test racks, an input/output station, and automated machinery configured to transfer storage devices between the input/output station and the plurality of test slots. Each of the plurality of test slots is configured to receive a storage device for testing. The input/output station includes an input transfer station that is configured to receive storage devices, stock the storage devices in spaced relation to each other, and present the storage devices for servicing by the automated machinery. The input/output station also includes an output transfer station that is configured to receive tested storage devices from the automated machinery, stock the tested storage devices in spaced relation to each other, and present the tested storage devices for retrieval.

According to another aspect, a method includes manually loading a plurality of storage devices into a storage device transfer station; actuating automated machinery to retrieve one storage device of the plurality of storage devices from the storage device transfer station; and actuating the automated machinery to deliver the one storage device to a test slot of the storage device testing system and insert the one storage device in the test slot. The storage device transfer station is configured to receive and support the plurality of storage devices such the plurality of storage devices are maintained in spaced relation to each other.

Embodiments of the disclosed methods, systems and devices may include one or more of the following features.

In some embodiments, the conveyor assembly includes a pair of continuous loops arranged to receive a plurality of storage devices therebetween. The continuous loops can include belts, wire mesh or chains.

In some cases, the conveyor assembly can include a continuous loop and a plurality of platforms extending outwardly from the continuous loop. Each of the plurality of platforms can be configured to receive and support a storage device. Each of the plurality of platforms can include a first portion connected to the continuous loop, and a second portion pivotally connected to the first portion.

In some embodiments, the storage device transfer station can also include an actuator that is arranged to advance a storage device at least partially out of the conveyor assembly and at least partially into the second slot.

In some cases, the storage device transfer station can also include a feeder conveyor that is arranged to assist in moving a storage device through the first slot.

In some embodiments, the storage device transfer station can also include a detector and control electronics in communication with the detector. The detector can be arranged to detect the presence of a storage device within the second slot, and the control electronics can be configured to control movement of the conveyor assembly based, at least in part, on signals received from the detector.

In some cases, the conveyor assembly is operable to convey the plurality of storage devices between the first slot and the second slot under gravity.

In some embodiments, the storage device transfer station includes an electric motor drivably connected to the conveyor assembly, and control electronics in communication with the electric motor. The control electronics can be configured to control movements of the conveyor assembly via the electric motor.

In some cases, the first slot is configured to receive storage devices, e.g., one at a time, from an operator.

In some embodiments, the second slot is configured to present storage devices, e.g., one at a time, for servicing by the automated machinery. In some cases, the second slot is configured to receive storage devices, e.g., one a time, from the automated machinery, and the first slot is configured to present storage devices, e.g., one at a time, for retrieval by an operator.

In some embodiments, each of the test slots are configured to receive and support a storage device transporter carrying a storage device for testing. In some embodiments, the input transfer station is configured to receive storage devices, e.g., one at a time, directly from an operator.

In some cases, the output transfer station is configured to present tested storage devices, e.g., one at a time, for retrieval by an operator.

Manually loading the plurality of storage devices can include loading the storage devices one at a time into the storage device transfer station.

Manually loading the plurality of storage devices can include transfer the storage devices into the storage device transfer station through a first slot of the transfer station.

In some embodiments, the storage device transfer station is configured to receive and support the plurality of storage devices such that the storage devices are vertically stacked and in spaced relation to each other.

In certain embodiments, a storage device transfer station can be used as either or both an input station and as an output station. For example, an input station, once emptied, could become an output feeding station, and vice-versa.

Storage devices (e.g., disk drives) can be stacked within a column, and drop to the bottom, where they can be retrieved by a storage device transporter held by a robot manipulator. Manual loading is simple, requiring an operator only to insert a storage device in the same slot over and over again, until the column is full.

A similar method can be used to unload storage devices. A robot, using the storage device transporter, loads the output drives in to top of an output column. When the column is full (or indeed at any time), an operator can remove the drives from the column one by one, by hand.

A system could use multiple input and output columns, plus a signaling system to indicate when a column is empty or full, to achieve maximum throughput with reduced or no wait times to load or unload drives. Because the column is so space-efficient, thousands of storage devices can be queued in a relative small space. The use of multiple output columns also allows pre-sorting of output storage devices by their test results.

Storage devices can be simply stacked on each other and fed by gravity.

Alternatively or additionally, the storage devices can be put in U-shaped guides (like card guides for a PC board) so they do not touch or scratch each other. A damping system can allow gravity to still be the motive force.

Alternatively or additionally, a motorized belt-, chain-, or gear-driven elevator can be used to move the storage devices.

Alternatively or additionally, the operator can see the entire front of the column and load/unload the storage devices manually in to individual slots, rather than repetitively into the same slot. This removes the need for having the elevator advance between storage devices when loading or unloading.

Alternatively or additionally, the storage devices can be loaded from or near the bottom of the column, and the robot can remove them from or near the top of the column. This can allow the column to be greater than human reachable height.

Alternatively or additionally, the drives can be loaded together with a storage device transporter, and the robot manipulates the combination.

Alternatively or additionally, the column can form a continuous loop, using a belt or chain. It can be one continuous load or unload loop, or one side can be used for load, the other for unload (only if the entire front is exposed, so the two sides can still be accessed if they get out of sync).

Alternatively or additional, these methods can be used to load or unload storage device transporters from the systems.

Alternatively or additionally, these methods can be used in an automated factory, simply to provide some queuing or buffering between process steps. For example, the manual loading and unloading can be replaced by a conveyor or robot interface.

Embodiments can include one or more of the following advantages.

Embodiments of the disclosed systems, methods, and devices can help to reduce human operator wait time associated with loading and unloading storage devices into/from a storage device testing system. For example, in some embodiments, a bulk load/unload transfer station can allow a human operator to load/unload many storage devices into a testing system at once, thereby freeing the operator to perform other tasks between load/unload operations.

A bulk load and/or unload system can also afford more opportunity to improve the handling of storage devices. For example, if one human operator loads many storage devices at once, e.g., sequentially during a single loading operation of limited duration, the number of opportunities to introduce storage device presentation errors is reduced as compared to loading storage devices continuously over an extended period of time.

A bulk load and/or unload system can also allow for presorting of output storage devices into different queues or containers.

In some embodiments, the disclosed systems, methods, and devices can allow a large number of storage devices to be queued for input and/or output. Some embodiments allow for bulk transfer of storage devices, e.g., into a storage device testing system, without the use of specialized totes or other specialized container.

In some embodiments, the disclosed systems, methods, and devices provide means of achieving many of the benefits of a fully automated factory (e.g., reliability, repeatability, and density) using a manual, yet bulk oriented input/output station.

Bulk feeding of storage devices can help to provide for increased throughput by reducing the amount of human intervention.

Bulk feeding of storage devices can help to provide for increased throughput by limiting the amount of human intervention to discrete and spaced apart intervals of time. This can help to reduce presentation error by reducing the likelihood that an operator will lose attention or focus over time, e.g., as compared to a system in which an operator continuously feeds storage devices into the system (or removes storage devices therefrom) over an extended period of time.

Bulk queuing/stocking of storage devices in a vertical stack can allow for an efficient utilization of space (e.g., factory floor space).

Other aspects, features, and advantages are in the description, drawings, and claims.

### DESCRIPTION OF DRAWINGS

FIG. 1 is a perspective view of a storage device testing system.

FIG. 2 is a perspective view of a test slot assembly.

FIGS. 3A and 3B are perspective views of a transfer (input/output) station.

FIGS. 4A and 4B are side and top views, respectively, of a storage device testing system.

FIGS. 5A and 5B are perspective views of a storage device transporter.

FIG. 6A is a perspective view of a storage device transporter supporting a storage device.

FIG. 6B is a perspective view of a storage device transporter carrying a storage devices aligned for insertion into a test slot.

FIGS. 7A and 7B are perspective and top views, respectively, of a storage devices testing system including a controller.

FIGS. 8A and 8B are top and side views, respectively, of a storage device transfer station.

FIG. 8C is a cross-sectional side view of the storage device transfer station of FIG. 8A taken along line 8C-8C.

FIG. 8D is a cross-sectional front view of the storage device transfer station of FIG. 8B taken along line 8D-8D.

FIG. 9A is a front view of a conveyor assembly.

FIG. 9B is a top view of a conveyor assembly.

FIG. 10A is a detailed cross-sectional side view of a first slot of a storage device transfer station taken from FIG. 8C.

FIG. 10B is a detailed cross-sectional front view of a first slot of a storage device transfer station taken from FIG. 8D.

FIG. 11A is a detailed cross-sectional side view of a second slot of a storage device transfer station taken from FIG. 8C.

FIG. 11B is a detailed cross-sectional front view of a second slot of a storage device transfer station taken from FIG. 8D.

FIG. 12A is a detailed cross-sectional side view of a second slot, of a storage device transfer station, including a pedestal.

FIG. 12B is a detailed cross-sectional front view of a second slot, of a storage device transfer station, including a pedestal.

FIGS. 13A and 13B are perspective and top views, respectively, of a storage device testing system having a cylindrical layout.

FIG. 13C is a perspective view of the storage device testing system of FIGS. 13A and 13B, showing a lift (with test racks removed).

FIG. 14A is a perspective view of a storage device transfer station.

FIGS. 14B is a cross-sectional front view of the storage device transfer station of FIG. 14A.

FIG. 14C is a cross-section side view of the storage device transfer station of FIG. 14A.

FIGS. 15A and 15B are cross-sectional side and front views, respectively, of a storage device transfer station including a motorized conveyor assembly.

FIG. 16 is a cross-sectional side view of a storage device transfer station including a displaceable (elevating) pedestal.

FIG. 17A is a perspective view of a storage device transfer station.

FIGS. 17B is a cross-sectional side view of the storage device transfer station of FIG. 17A.

FIG. 17C is a perspective view of a conveyor assembly of the storage device transfer station of FIG. 17A.

FIGS. 18A and 18B are cross-sectional side and front views, respectively, of a storage device transfer station including a motorized conveyor assembly.

FIG. 19 is a cross-sectional side view of a storage device transfer station including a displaceable (elevating) pedestal.

Like reference symbols in the various drawings indicate like elements.

### DETAILED DESCRIPTION

### System Overview

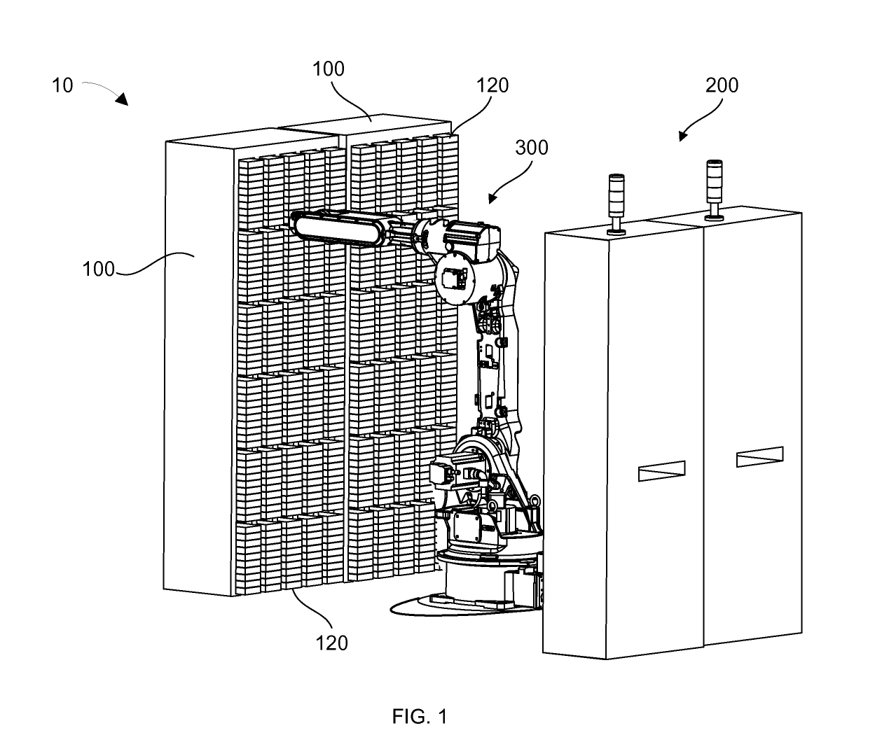

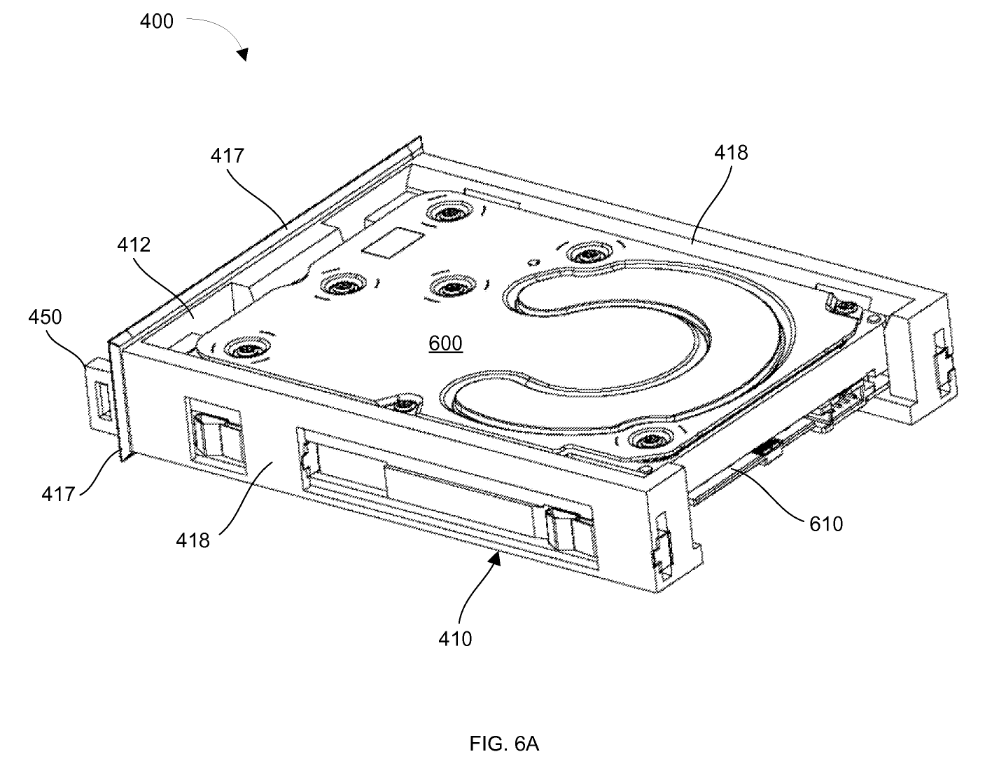

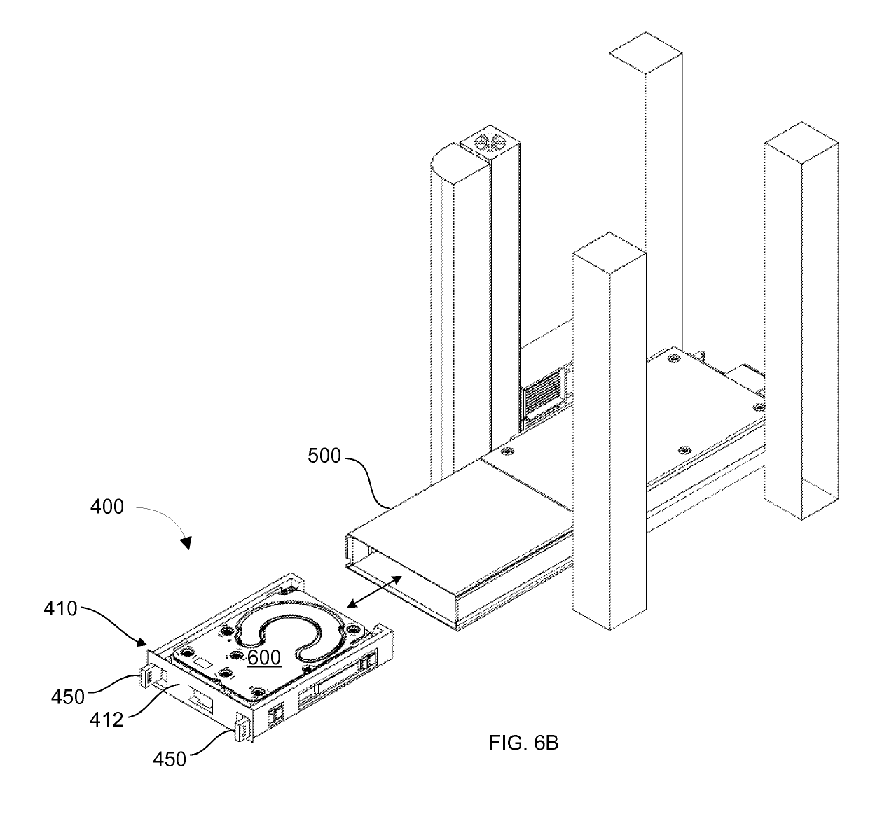

As shown in FIG. 1, a storage device testing system 10 includes one or more test racks 100, a transfer station 200, and a robot 300 that is operable to transfer storage devices 600 (FIG. 6A) between the transfer station 200 (i.e., input/output station) and the test racks 100.

A storage device, as used herein, includes disk drives, solid state drives, memory devices, and any device that requires asynchronous testing for validation. A disk drive is generally a non-volatile storage device which stores digitally encoded data on rapidly rotating platters with magnetic surfaces. A solid-state drive (SSD) is a data storage device that uses solid-state memory to store persistent data. An SSD using SRAM or DRAM (instead of flash memory) is often called a RAM-drive. The term solid-state generally distinguishes solid-state electronics from electromechanical devices.

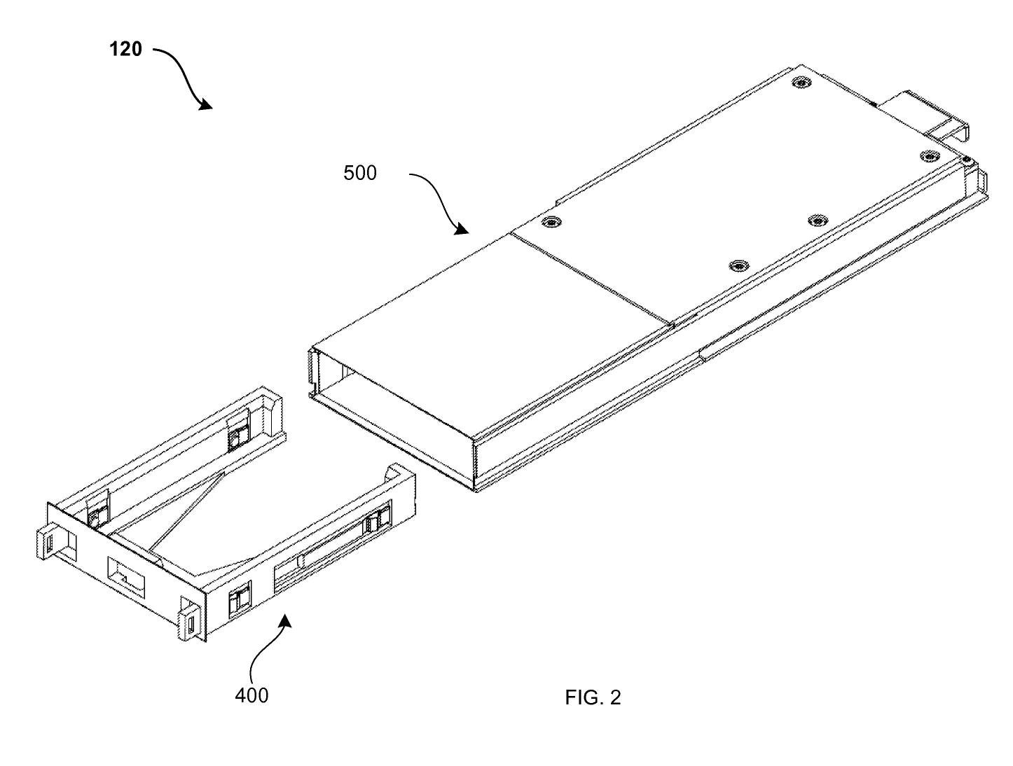

Each test rack 100 generally includes a plurality of test slot assemblies 120. As shown in FIG. 2, each test slot assembly 120 includes a storage device transporter 400 and a test slot 500. The storage device transporter 400 is used, e.g., in cooperation with the robot 300, for transporting the storage devices 600 between the transfer station 200 and the test slots 500.

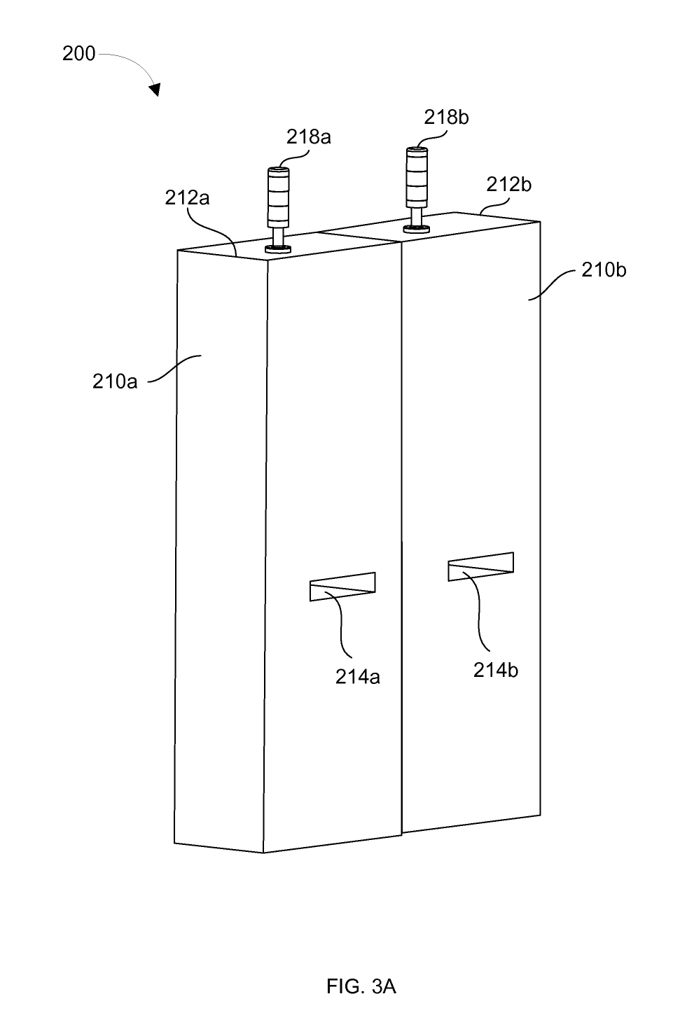

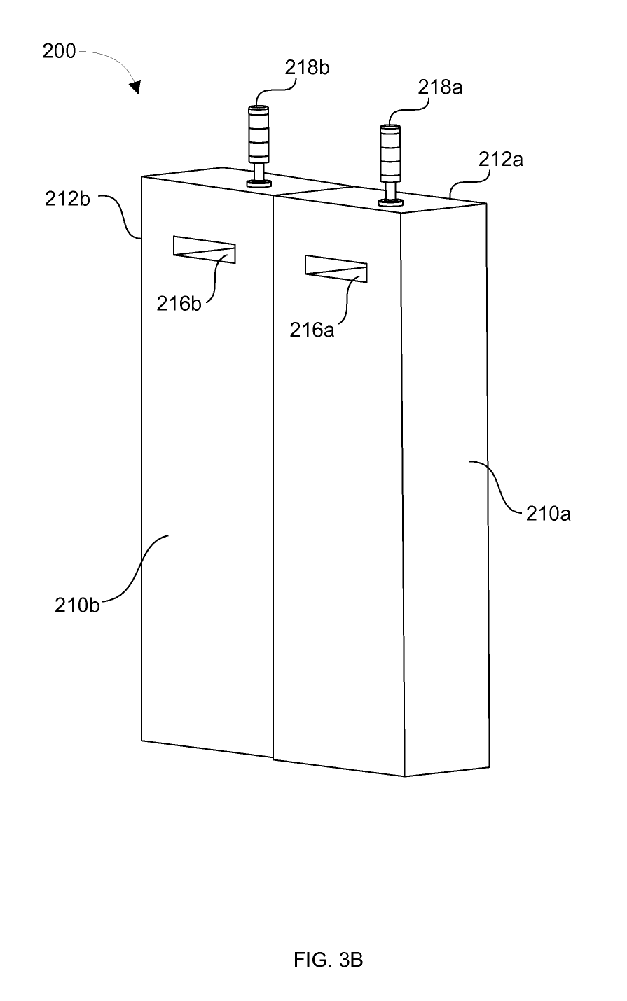

Referring to FIGS. 3A and 3B, in some implementations, the transfer station 200 includes an input transfer station 210a and an output transfer station 210b. The input transfer station 210a includes a housing 212a, a first slot 214a, a second slot 216a, and a status indicator light 218a. The first slot 214a is configured to receive storage devices 600, e.g., one at a time, from an operator. The received storage devices 600 are stocked in bulk, e.g., in a vertical stack and in spaced relation to each other, within the housing 212a. The second slot 216a is configured to present the stock of storage devices 600, e.g., one at a time, for servicing by the robot 300. The status indicator light 218a provides a visual indication, e.g., to an operator, of the status of the input transfer station 210a. For example, the status indicator light 218a can be configured to light up or emit a colored light (e.g., a yellow light) when there is space for one or more additional storage devices 600 in the input transfer station 210a, e.g., to replenish the stock.

The output transfer station 210b also includes a housing 212b, a first slot 214b, a second slot 216b, and a status indicator light 218b. The second slot 216b is configured to receive storage devices 600, e.g., one at a time, from the robot 300. The received storage devices 600 are stocked in bulk, e.g., in a vertical stack and in spaced relation to each other, within the housing 212b of the output transfer station 210b. The first slot 214b of the output transfer station 210b is configured to present the stock of storage devices 600, e.g., one at a time, for removal (e.g., by an operator). The status indicator light 218b provides a visual indication, e.g., to an operator, of the status of the output transfer station 210b. For example, the status indicator light 218b can be configured to light up or emit a colored light (e.g., a green light) when there are storage devices 600 (e.g., tested storage devices) that are ready to be retrieved from the output transfer station 210b.

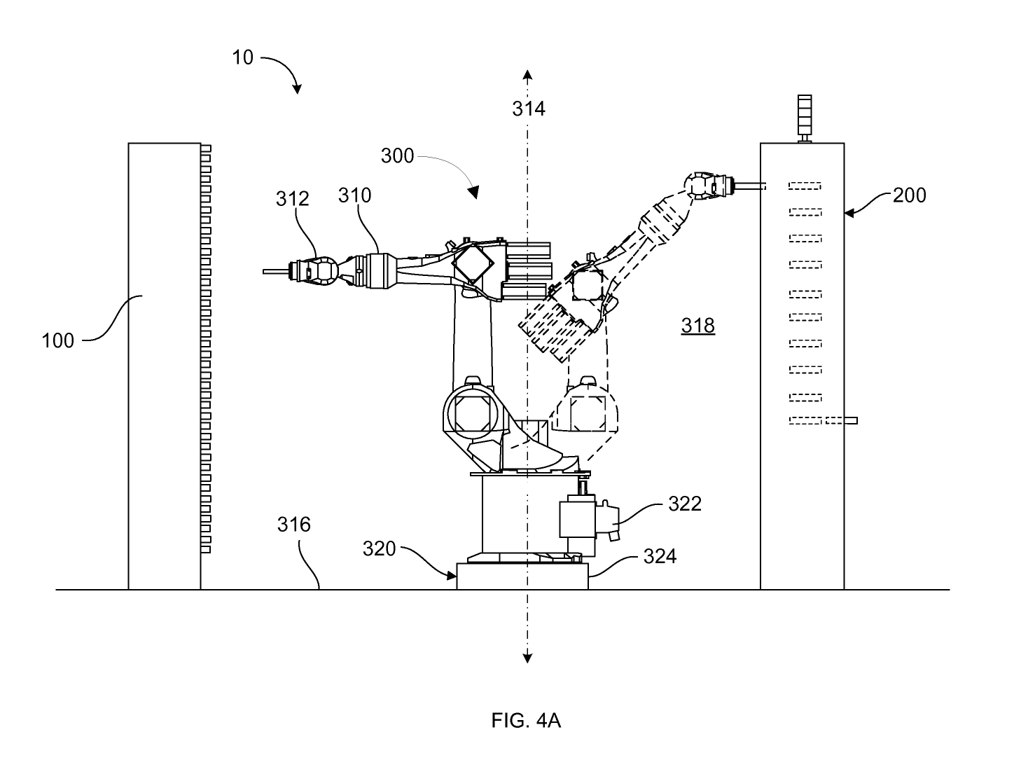

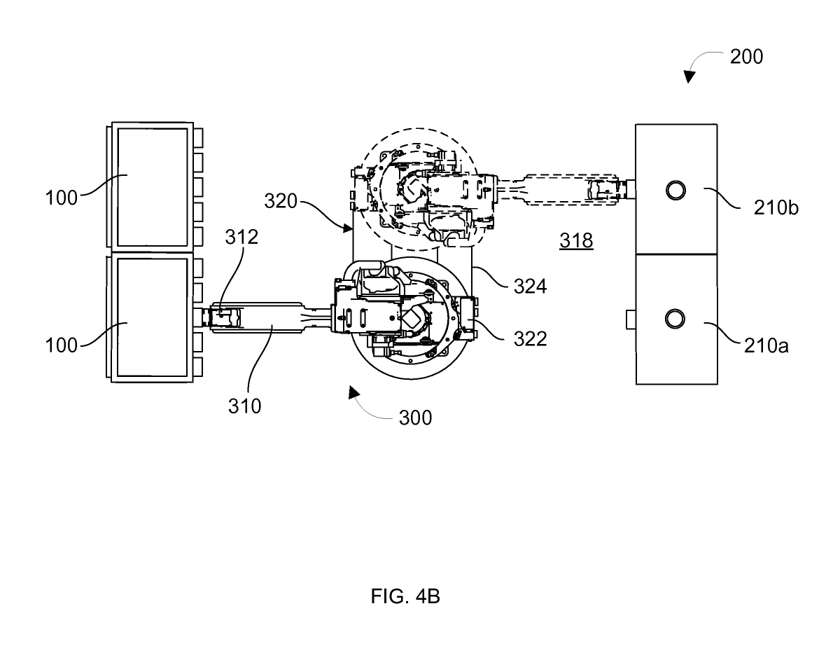

As shown in FIGS. 4A and 4B, the robot 300 includes a robotic arm 310 and a manipulator 312 disposed at a distal end of the robotic arm 310. A detailed description of the manipulator and other details and features combinable with those described herein may be found in the following U.S. patent application filed concurrently herewith, entitled “Transferring Disk Drives Within Disk Drive Testing Systems”, with attorney docket number: 18523-073001, inventors: Evgeny Polyakov et al., and having assigned Ser. No. 12/104,536, the entire contents of the aforementioned applications are hereby incorporated by reference. The robotic arm 310 defines a first axis 314 (FIG. 4A) normal to a floor surface 316 and is operable to rotate through a predetermined arc about and extends radially from the first axis 314 within a robot operating area 318.

The robot 300 can be disposed on a guide system 320. In some implantations, the guide system 320 includes a linear actuator configured to move the robot 300 adjacently along the test racks 100 to allow the robot 300 to service test slots 500 of more than one rack 100. In other implementations, the robot 300 can include a drive system 322 configured to move the robot 300 along the guide system 320. For example, the robot 300 may be mounted on a rail system 324 and the drive system 322 moves the robot 300 along the rail system 324. The guide system 320 may be scalable (e.g., in length) and may accommodate multiple robots, for example, to support either longer test racks 100 or to further reduce the area serviced by each robot 300 to increase throughput and/or accommodate shorter testing times.

The robotic arm 310 is configured to independently service each test slot 500 by transferring storage devices 600 between the input transfer station 210a and the test racks 100. In particular, the robotic arm 310 is configured to remove a storage device transporter 400 from one of the test slots 500 with the manipulator 312, then pick up a storage device 600 from the second slot 216a at the input transfer station 210a with the storage device transporter 400, and then return the storage device transporter 400, with a storage device 600 therein, to the test slot 500 for testing of the storage device 600. After testing, the robotic arm 310 retrieves the storage device transporter 400, along with the supported storage device 600, from one of the test slots 500 and returns it to the second slot 216b of the output transfer station 210b (or moves it to another one of the test slots 500) by manipulation of the storage device transporter 400 (i.e., with the manipulator 312).

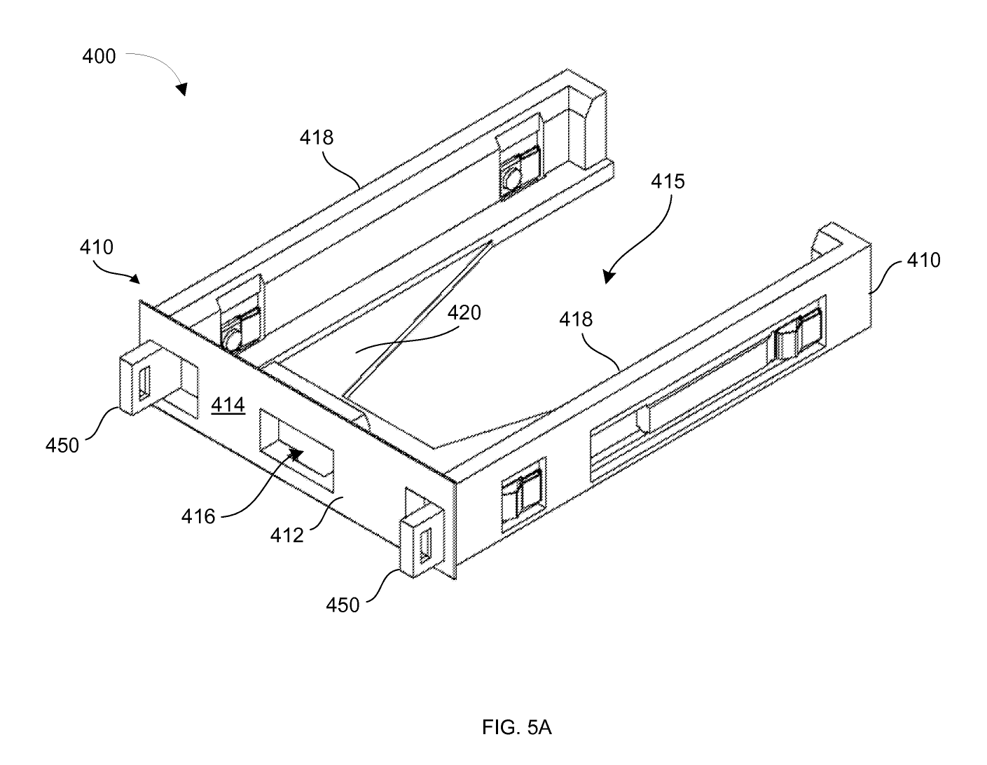

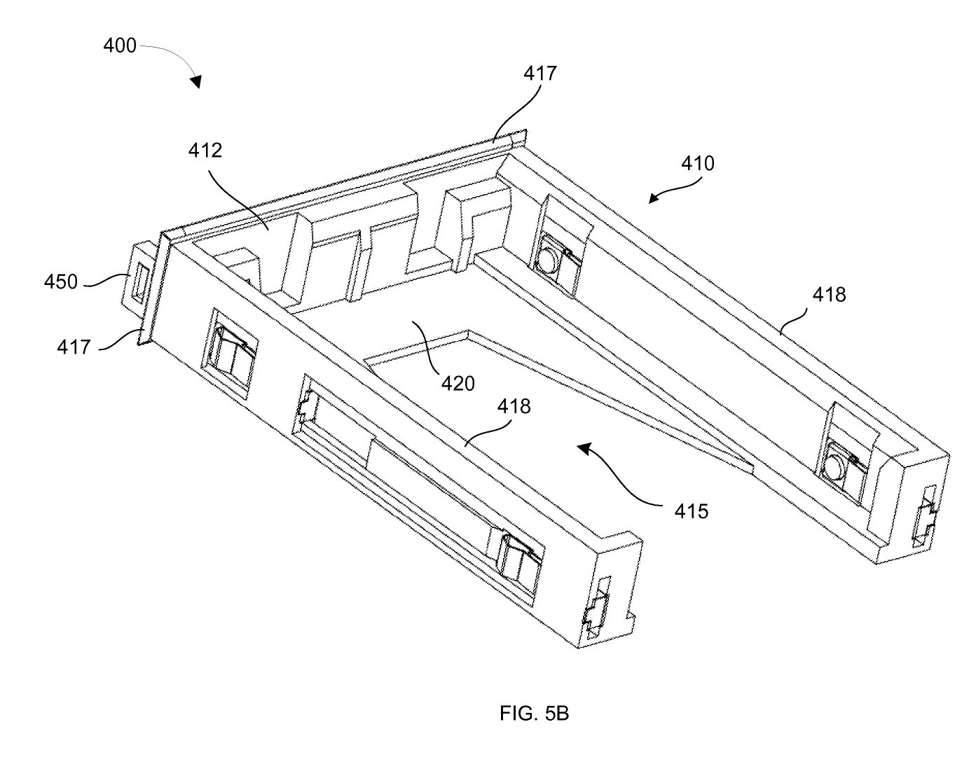

Referring to FIGS. 5A and 5B, the storage device transporter 400 includes a frame 410 and a clamping mechanism 450. The frame 410 includes a face plate 412. As shown in FIG. 5A, along a first surface 414, the face plate 412 defines an indentation 416. The indentation 416 can be releaseably engaged by the manipulator 312 (FIGS. 4A and 4B) of the robotic arm 310, which allows the robotic arm 310 to grab and move the transporter 400. In use, one of the storage device transporters 400 is removed from one of the test slots 500 with the robot 300 (e.g., by grabbing, or otherwise engaging, the indentation 416 of the transporter 400 with the manipulator 312 of the robot 300). The frame 410 defines a substantially U-shaped opening 415 formed by sidewalls 418 and a base plate 420 that collectively allow the frame 410 to be used to retrieve the storage devices 600 from the second slot 216a of the input transfer station 210a.

As illustrated in FIGS. 6A and 6B, with one of the storage devices 600 in place within the frame 410, the storage device transporter 400 and the storage device 600 together can be moved by the robotic arm 310 (FIG. 4A) for placement within one of the test slots 500. The manipulator 312 (FIG. 4A) is also configured to initiate actuation of a clamping mechanism 450 disposed in the storage device transporter 400. This allows actuation of the clamping mechanism 450 before the transporter 400 is moved from the tote 220 to the test slot 500 to inhibit movement of the disk drive 600 relative to the disk drive transporter 400 during the move. Prior to insertion in the test slot 500, the manipulator 312 can again actuate the clamping mechanism 450 to release the disk drive 600 within the frame 410. This allows for insertion of the storage transporter 400 into one of the test slots 500. The clamping mechanism 450 may also be configured to engage the test slot 500, once received therein, to inhibit movement of the storage device transporter 400 relative to the test slot 500. In such implementations, once the storage device 600 is fully inserted in a test position in the test slot 500, the clamping mechanism 450 is engaged again (e.g., by the manipulator 312) to inhibit movement of the storage device transporter 400 relative to the test slot 500. The clamping of the storage device transporter 400 in this manner can help to reduce vibrations during testing. A detailed description of the clamping mechanism 450 and other details and features combinable with those described herein may be found in the following U.S. patent application filed Dec. 18, 2007, entitled “DISK DRIVE TRANSPORT, CLAMPING AND TESTING”, with attorney docket number: 18523-067001, inventors: Brian Merrow et al., and having assigned Ser. No. 11/959,133, the entire contents of the which are hereby incorporated by reference.

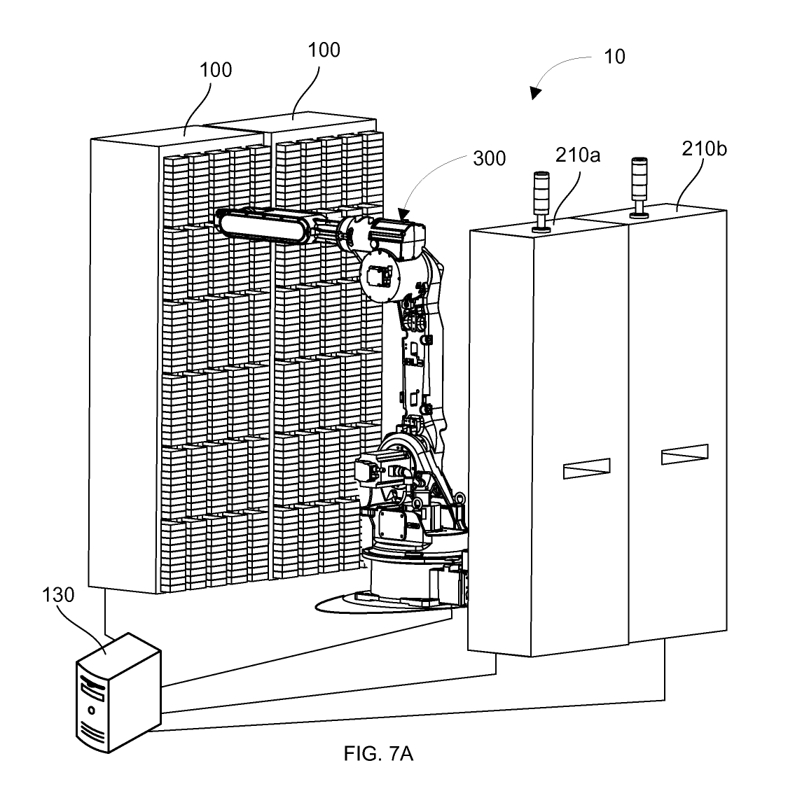

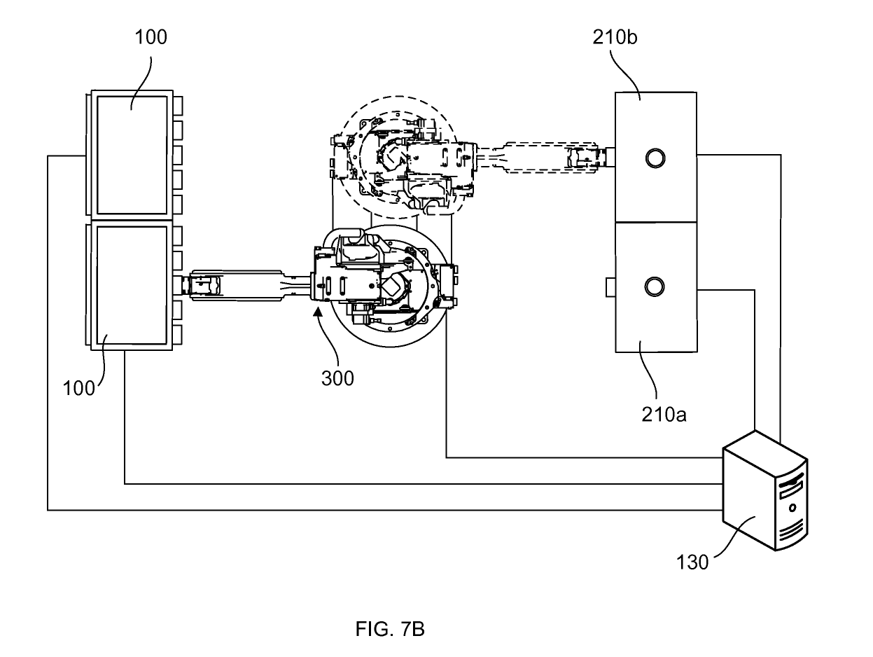

Referring to FIGS. 7A and 7B, in some implementations, the disk drive testing system 10 also includes at least one controller 130 (e.g., computing device) that communicates with each of the test racks 100, the transfer station 200, and the robot 300. The controller 130 monitors the status of the input and output transfer stations 210a, 210b, and can coordinate servicing of the test slots 500 by the robot 300 based, at least in part, on the status of the input and output transfer stations 210a, 210b.

### Transfer (Input/Output) Station

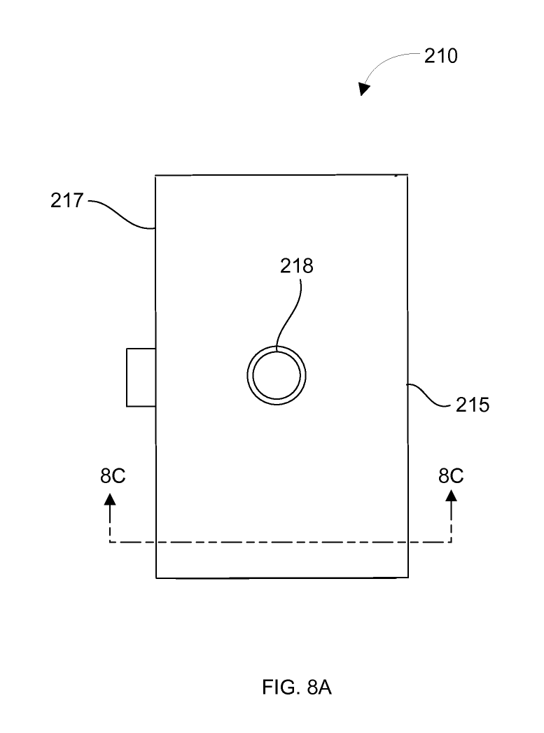

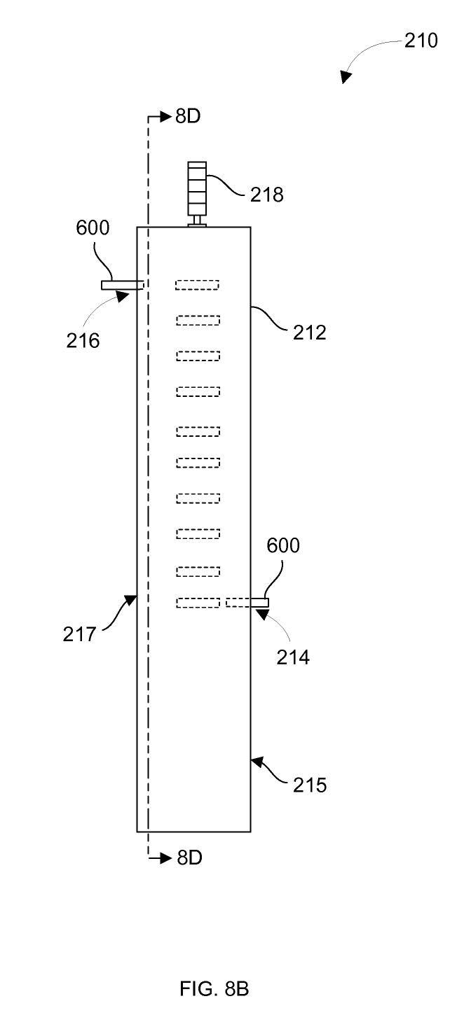

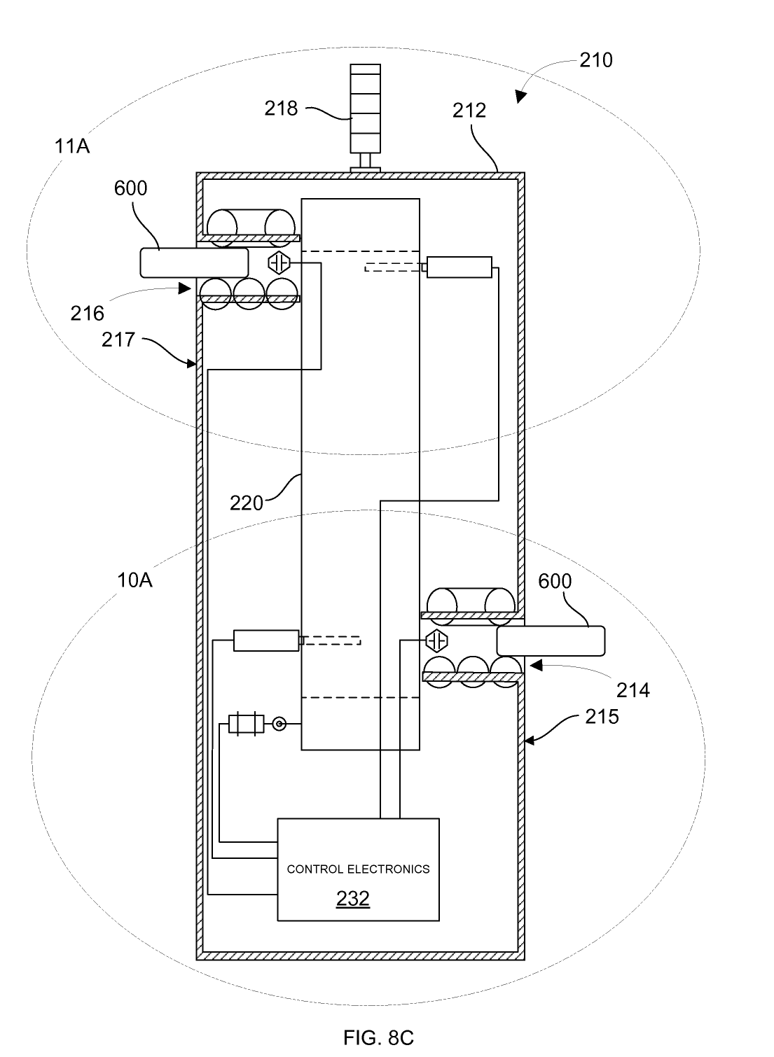

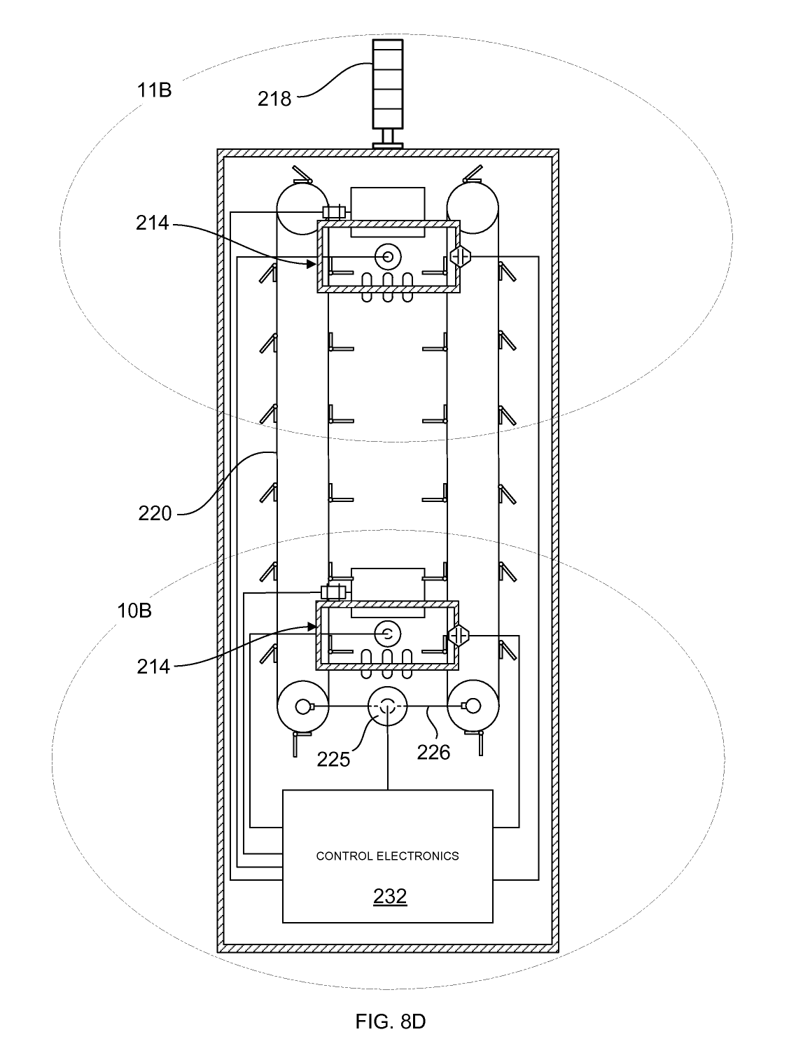

As mentioned above, the transfer station 200 includes the input transfer station 210a and the output transfer station 210b. Both the input transfer station 210a and the output transfer station 210b can have the same general construction. For example, FIGS. 8A-8D illustrate a transfer station 210 that could be used as an input transfer station and/or as an output transfer station. The transfer station 210 includes a housing 212 (e.g., a sheet metal enclosure) with a first slot 214 being disposed along a first surface 215 of the housing 212. The first slot 214 functions as an interface between an operator and the transfer station 210. A second slot 216 is disposed along a second surface 217 of the housing 212. The second slot 216 functions as an interface between the robot 300 and the transfer station 210. Disposed within the housing 212 is a conveyor assembly 220. The conveyor assembly 220 receives and stores storage devices 600, such as disk drives, and operates to convey the storage devices 600 between the first and second slots 214, 216.

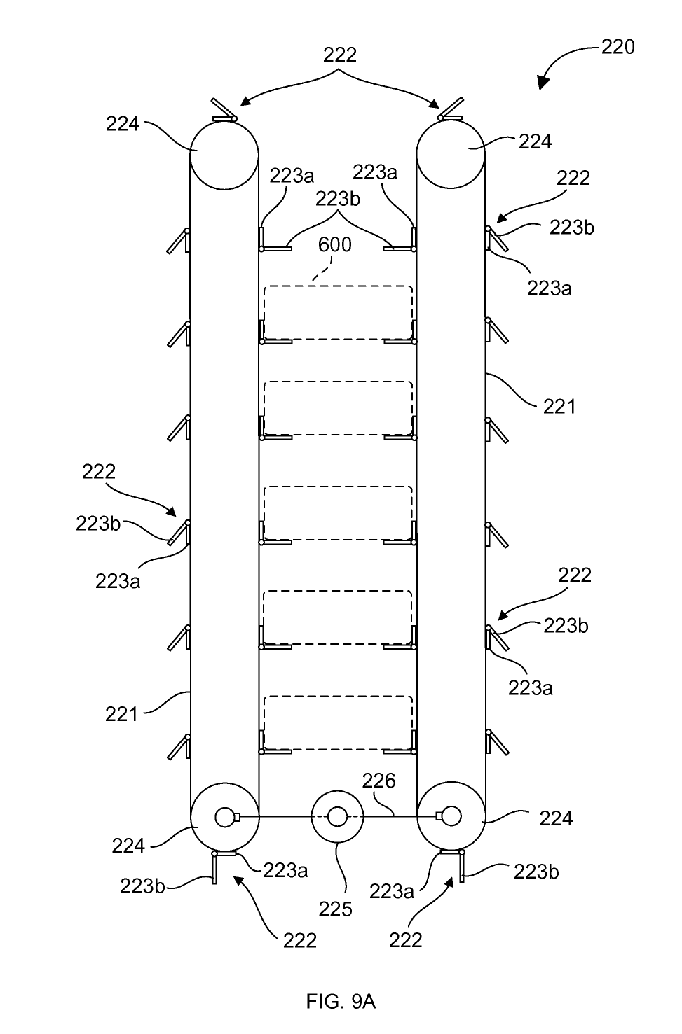

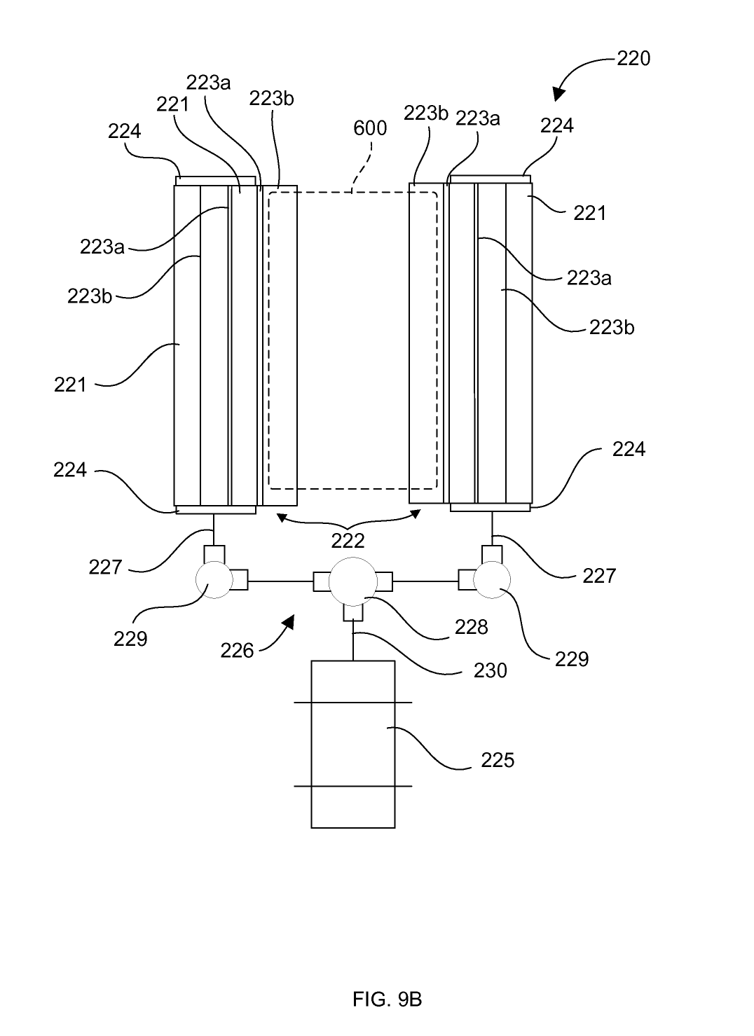

As shown in FIGS. 9A and 9B, the conveyor assembly 220 includes a parallel pair of continuous loops 221 and a plurality of hinged platforms 222. Each of the platforms 222 includes a first portion 223a that is connected to a corresponding one of the loops 221, and a second portion 223b that is pivotally connected to the first portion 223a. The hinged platforms 222 are arranged in pairs such that each pair of the platforms 222 can receive and support a storage device 600 between the loops 221. Consecutive pairs of the platforms 222 are spaced apart from each other along a length of the loops 221 such that a plurality of storage devices 600 can be supported and maintained in spaced relation to each other along a length of the loops 221. The spacing of the storage devices 600 can help to prevent the storage devices 600 from rubbing against and scratching each other. The loops 221 can be belts (e.g., plastic or rubber belts), wire mesh, or chains. The platforms 222 can be formed from metal (e.g., sheet metal), or plastic and can be connected to the loops 221, e.g., via adhesive, welds, or hardware (e.g., screws).

The loops 221 are mounted on rotatable spindles 224, which allow the loops 221 to rotate and thereby convey the storage devices 600 between locations along the length of the loops 221. A pair of the spindles 224, each associated with a corresponding one of the loops 221, is drivably connected to an electric motor 225 (e.g., a stepper motor) via a drive train 226. Referring to FIG. 9B, the drive train 226 includes a pair of drive shafts 227, each connected to an associated one of the spindles 224, and a differential 228. On the output side, the differential 228 is drivably connected to each of the drive shafts 227 via right angle gears 229. On the input side, the differential 228 is drivably connected to a shaft 230 of the electric motor 225. Rotation of the shaft 230 drives the spindles 224 through the drive train 226. The motor 225 is electrically connected to control electronics 232 which control operation of the motor 225.

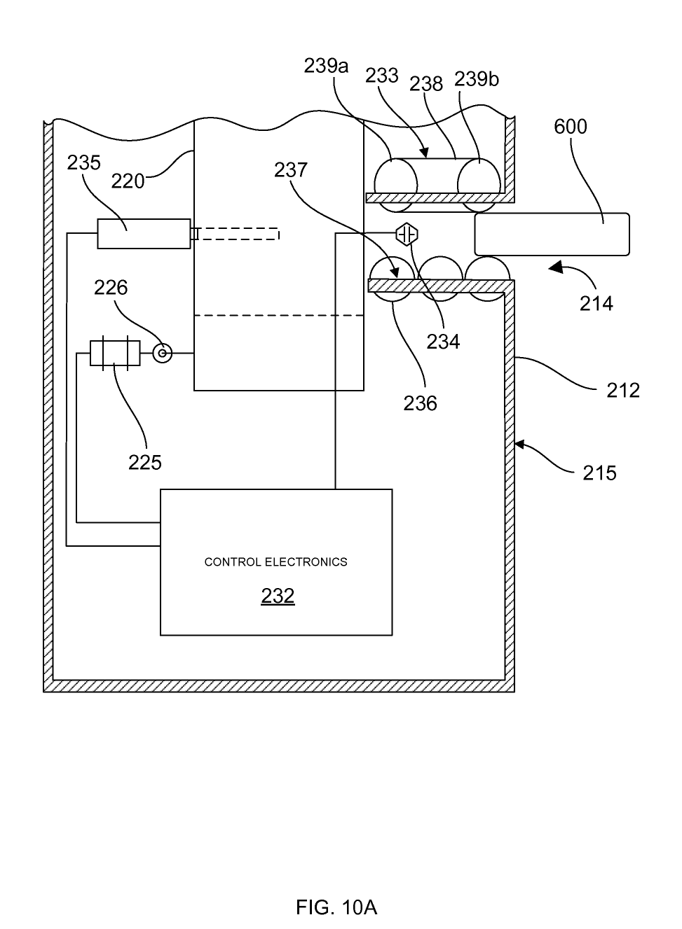

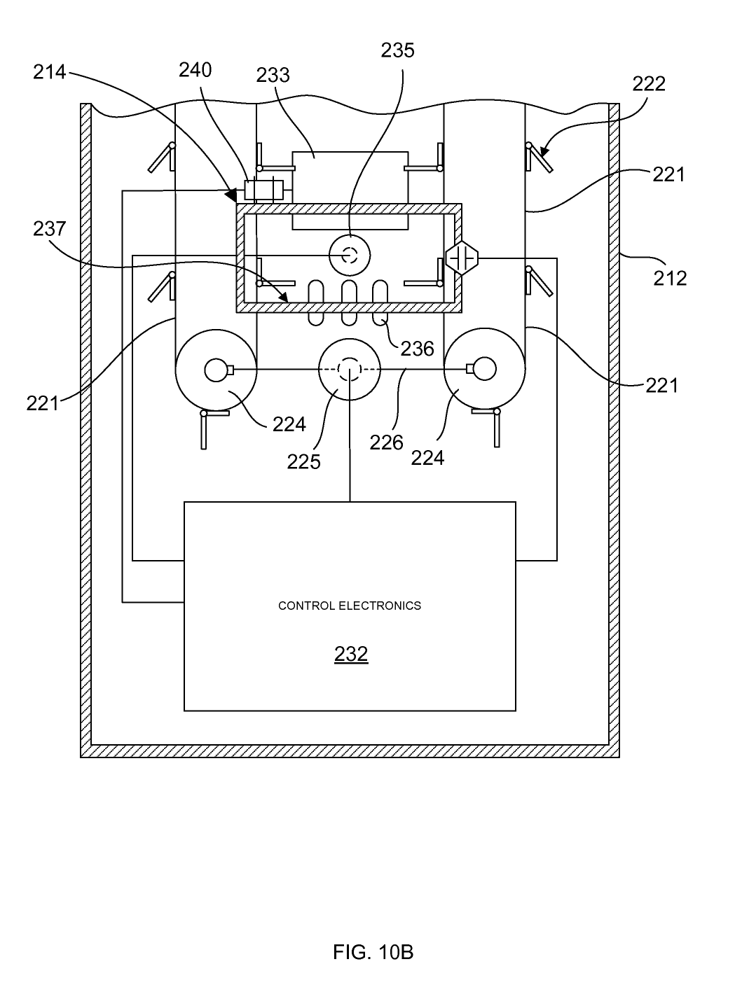

Referring to FIGS. 10A and 10B, associated with the first slot 214 are a first feeder conveyor 233, a first detector 234, and a first linear actuator 235 (e.g., a solenoid). These devices assist with the movement of storage devices into and/or out of the transfer station 210. When used as an input transfer station 210a an operator will insert a storage device 600 into the first slot 214. A plurality of wheels or rollers 236 are provided on a lower surface 237 of the first slot 214, which allow storages devices 600 to move along a length of the first slot 214 without sliding and potentially scratching bottom surfaces of the storage devices 600. The first feeder conveyor 233 is disposed at least partially within the first slot 214 and is positioned to contact a top surface of a storage device 600 within the first slot 214.

The first feeder conveyor 233 generally includes a drive belt 238 (e.g., a rubber belt), spindles 239a, 239b, and a motor 240 (FIG. 10B) that is drivably connected to a first one of the spindles 239a. The motor 240 is electrically connected to, and controlled by, the control electronics 232. When a storage device 600 is inserted in the first slot 214 it is engaged by the drive belt 238 and movement of the drive belt 238, which is driven by the motor 240 via the spindles 239a, 239b, assists in moving the inserted storage device 600 through the first slot 214 and into a position within the conveyor assembly 220.

The first detector 234 operates cooperatively with the control electronics 232 to monitor a position of a storage device 600 passing through the first slot 214. For example, when the transfer station 210 is employed as an input transfer station 210a, the first detector 234 is used to determine whether and when an inserted storage device 600 is fully seated within the conveyor assembly 22. In this regard, the first detector 234 can be positioned to detect whether a storage device 600 is disposed within the first slot 214. If, based on signals received from the first detector 234, the control electronics 232 determine that a storage device 600 is positioned within the first slot 214, the first feeder conveyor 233 is driven to advance the storage device 600 through the first slot 214. The first detector 234 can include one or more sensing devices, such as optical detectors and/or electromechanical switches.

The first linear actuator 235 is provided for pushing storage devices 600 out of the conveyor assembly 220 and into the first slot 214, such as when the transfer station 210 is used an output transfer station 210b. More specifically, the first linear actuator 235 is positioned to engage a storage device 600 that is supported in the conveyor assembly 220 in a position directly adjacent to the first slot 214 and to advance the storage device 600 at least partially out of the conveyor assembly 220 and at least partially into the first slot 214. When the control electronics 232, via communication with the first detector 234, determine that a storage device 600 has been advanced into the first slot 214, the first feeder conveyor 233 is actuated to further advance the storage device 600 through the first slot 214 toward a position in which a portion of the storage device 600 extends outwardly from the first slot 214 for removal, e.g., by an operator.

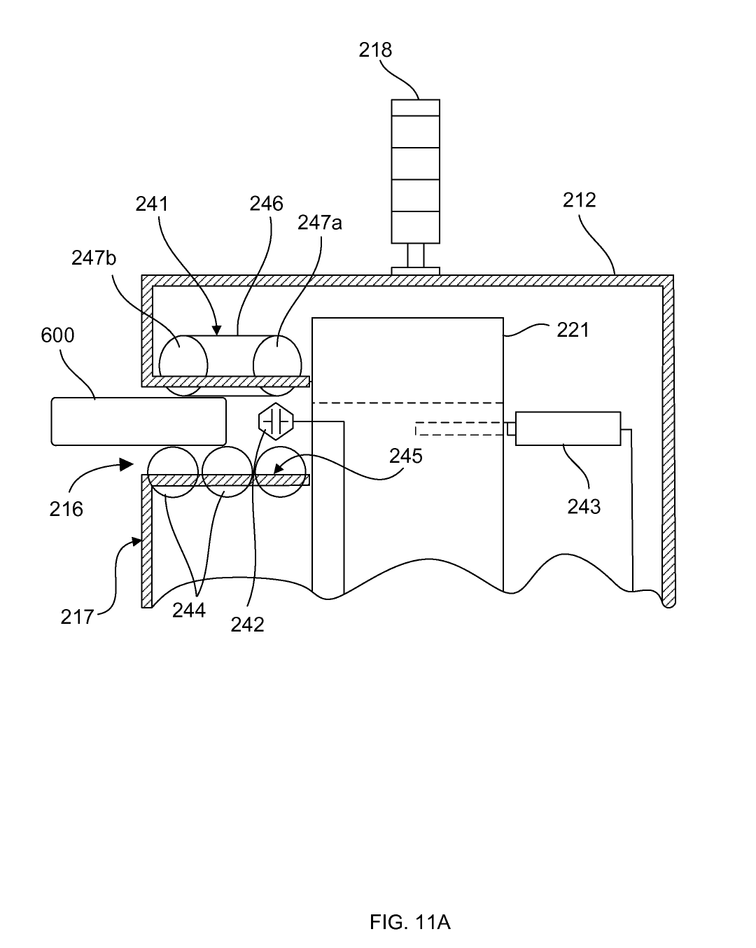

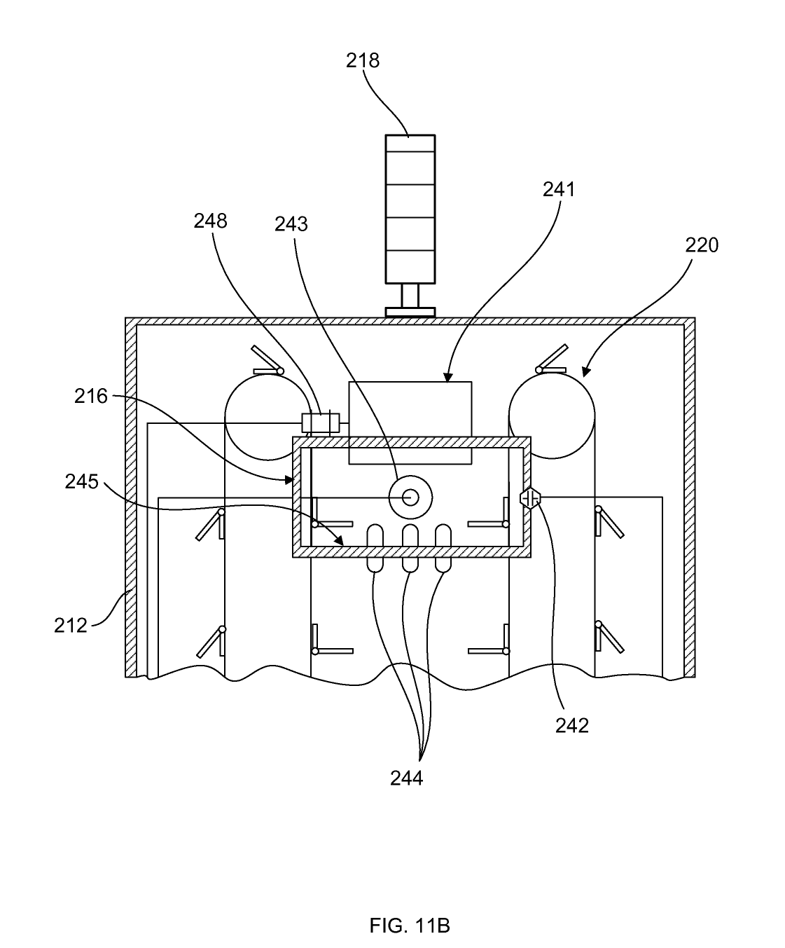

Referring to FIGS. 11A and 11B, associated with the second slot 216 is a second feeder conveyor 241, a second detector 242, and a second linear actuator 243 (e.g., a solenoid). These devices assist with the movement of storage devices 600 into and/or out of the transfer station 210 through the second slot 216. The second linear actuator 243 is provided for pushing storage devices 600 out of the conveyor assembly 220 and into the second slot 216, such as when the transfer station 210 is used an input transfer station 210b. In this regard, the second linear actuator 243 is positioned to engage a storage device 600 that is supported in the conveyor assembly 220 in a position directly adjacent to the second slot 216 and to advance the storage device 600 at least partially out of the conveyor assembly 220 and at least partially into the second slot 216.

A plurality of wheels or rollers 244 are provided on a lower surface 245 of the second slot 216, which allow storages devices 600 to move along a length of the second slot 216 without sliding and potentially scratching bottom surfaces of the storage devices 600. The second feeder conveyor 241 is disposed at least partially within the second slot 216 and is positioned to contact a top surface of a storage device 600 within the second slot 216 for advancing the storage device 600 along a length of the second slot 216.

The second feeder conveyor 241 generally includes a drive belt 246 (e.g., a rubber belt), spindles 247a, 247b, and a motor 248 (FIG. 11B) that is drivably connected to a first one of the spindles 247a. The motor 248 is electrically connected to, and controlled by, the control electronics 232 (FIGS. 8C and 8D). When a storage device 600 is inserted into the second slot 216 it is engaged by the drive belt 246 and movement of the drive belt 246, which is driven by the motor 248 via the spindles 247a, 247b, assists in moving the inserted storage device 600 through the second slot 216 and into a pick-up position within the second slot 216.

The second detector 242 operates cooperatively with the control electronics 232 (FIGS. 8C and 8D) to detect the presence and/or position of a storage device 600 disposed within the second slot 216. The second detector 242 can include one or more sensing devices, such as optical detectors and/or electromechanical switches. If, based on signals received from the second detector 242, the control electronics 232 determine that a storage device 600 is positioned within the second slot 216, the second feeder conveyor 241 is driven to advance the storage device 600 through the second slot 216 towards the pick-up position where it can be picked up by the robot 300. In this regard, the rollers 244 can be dimensioned to support a storage device 600 such that the robot 300 can scoop up the storage device 600 by position a storage device transporter 400 (FIG. 5B) underneath the storage device 600, with the rollers 244 fitting within the U-shaped opening 415 of the transporter 400, and then raising the transporter 400 to lift the storage device 600 off the rollers 244.

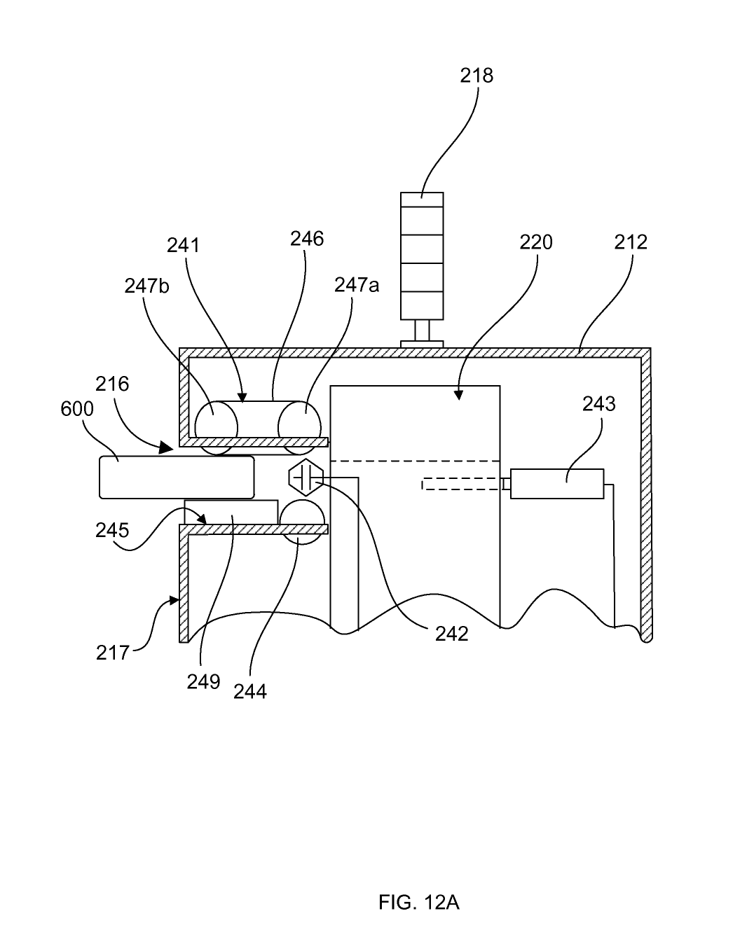

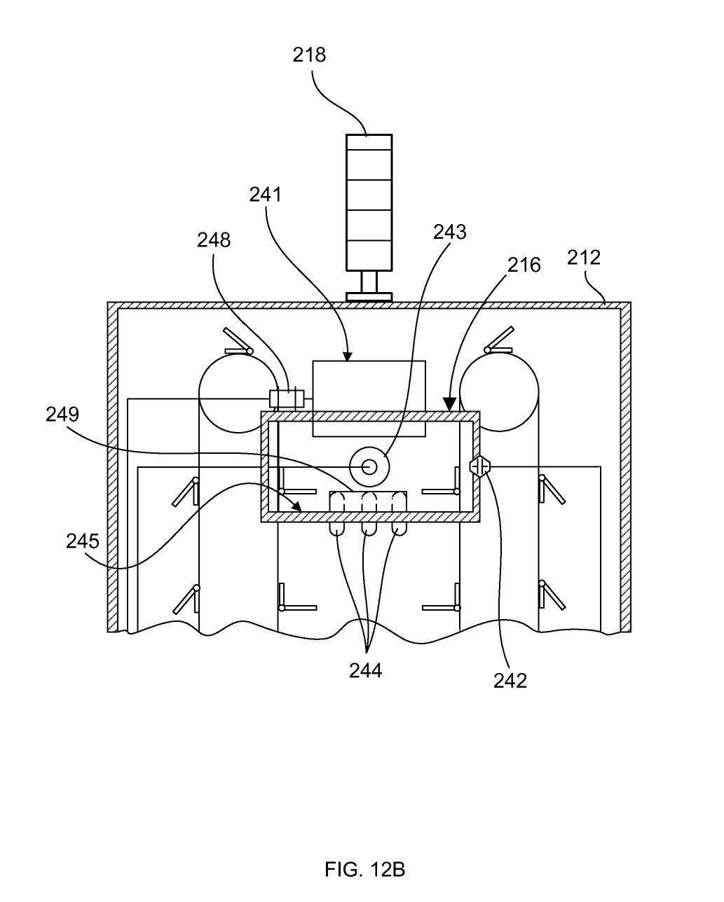

Referring to FIGS. 12A and 12B, in some embodiments, the second slot 216 can also include a pedestal 249 at the pick-up position. The second feeder conveyor 241 and the rollers 244 can be arranged to deliver a storage device 600 to sit atop the pedestal 249 where it can be picked up by the robot 300. The pedestal 249 can be dimensioned to hold the storage device in an elevated position above the lower surface 245 of the second slot 216. The width of the pedestal 249 allows the sidewalls 418 of the storage device transporter 400 to fit around the pedestal 249 such that the storage device transporter 400 can be positioned underneath a storage device 600 supported on the pedestal 249, and such that the pedestal 249 is accommodated in the U-shaped opening 415 of the storage device transporter 400.

When the transfer station 210 is employed as an output transfer station 210b, the robot 300 can place a tested storage device 600 in the second slot 216. When the control electronics 232, via communication with the second detector 242, determine that a storage device 600 has been inserted into the second slot 216, the second feeder conveyor 241 is actuated to further advance the storage device 600 through the second slot 216 and into a position within the conveyor assembly 220.

### Methods of Operation

In use, an operator will feed a plurality of storage devices 600, e.g., one at a time, into the first slot 214a of the input transfer station 210a until the conveyor assembly 220 (of the input transfer station 210a) is fully stocked with storage devices 600. The status of the conveyor assembly 220 of the input transfer station 210a is monitored by the control electronics 232 (of the input transfer station 210a) which control the status indicator light 218a. The status indicator light 218a on the input transfer station 210a will light up (e.g., illuminate a yellow light) when there space is available in the conveyor assembly 220 (of the input transfer station 210a) for an additional storage device 600. When the conveyor assembly 220 (of the input transfer station 210a) is fully stocked with storage devices 600, the status indicator light 218a will turn off (or provide a light of a different color).

As storage devices 600 are inserted into the first slot 214a of the input transfer station 210a, the control electronics 232 (of the input transfer station 210a) will detect, e.g., via the first detector 234, the presence of a storage device 600 in the first slot 214a and will actuate the first feeder conveyor 233 to advance the storage device 600 into position in the conveyor assembly 220 (of the input transfer station 210a). Once a storage device 600 is fully fed into position in the conveyor assembly 220 (of the input transfer station 210a) the control electronics 232 (of the input transfer station 210a) will actuate the conveyor assembly 220 to move the received storage device 220 upward towards the second slot 216a to make space for another storage device 600. This is repeated for each storage device 600 that is fed into the input transfer station 210a until the conveyor assembly 220 (of the input transfer station 210a) is fully stocked with storage devices 600, at which point the operator is free to walk away to perform other tasks.

When the input transfer station 210a is fully stocked with storage devices 600, the first storage device 600 that was fed into the input transfer station 210a will be aligned with the second slot 216a. At this point, the control electronics 232 (of the input transfer station 210a) will actuate the second linear actuator 243 (of the input transfer station 210a) to push the storage device 600 into the second slot 216a. The control electronics 232 (of the input transfer station 210a) will then detect (via the second detector 242) the presence of the storage device 600 in the second slot 216a, and, in response, will actuate the second feeder conveyor 241 (of the input transfer station 210a) to advance the storage device 600 into the pick-up position, where the storage device 600 can be retrieved by the robot 300. After the storage device 600 is removed from the input transfer station 210a by the robot 300, the control electronics 232 (of the input transfer station 210a) will detect that the second slot 216a is empty, and, in response, will move the next storage device 600 into alignment with the second slot 216 (e.g., via movement of the conveyor assembly 220 of the input transfer station 210a) and then out of the conveyor assembly 220 and into the pick-up position in the second slot 216a. This process can be repeated for each subsequent storage device 600 stored in the input transfer station 210a. Thus, a plurality of storage devices 600 can be stored, and queued, in the input transfer station 210a allowing the operator to perform other tasks while the storage devices 600 are automatically fed, e.g., one at a time, to the robot 300 by the input transfer station 210a.

The robot 300 can retrieve a storage device 600 from the input transfer station 210a using one of the storage device transporters 400. Then, the robot 300 can deliver the storage device transporter 400 and the retrieved storage device 600 to one of the test slots 500 for testing of the storage device 600. This process can be repeated for each of the storage devices stored in the input transfer station 210a.

The robot 300 will also remove a tested storage device 600 from one of the test slots 500, by removing the storage device transporter 400 supporting the tested storage device 600 from the test slot 500. The robot 300 will then deliver the tested storage device 600 to the second slot 216b of the output transfer station 210b. The control electronics 232 of the output transfer station 210b will detect, e.g., via the second detector 242 (of the output transfer station 210b), the presence of a storage device 600 in the second slot 216b, and, in response, will actuate the second feeder conveyor 241 (of the output transfer station 210b) to feed the storage device 600 into the conveyor assembly 220 of the output transfer station 210b. This can be repeated for each storage device 600 that is fed into the output transfer station 210b until the conveyor assembly 220 (of the output transfer station 210b) is fully stocked with storage devices 600. When the output transfer station 210b is fully stocked with storage devices 600, the first storage device 600 that was fed into the output transfer station 210b will be aligned with the first slot 214b. At this point, the control electronics 232, of the output transfer station 210b, will actuate the first linear actuator 235 (of the output transfer station 210b) to push the storage device 600 into the second slot 216b. The control electronics 232 (of the output transfer station 210b) will then detect (via the first detector 234 of the output transfer station 210b) the presence of the storage device 600 in the first slot 214b, and, in response, will actuate the first feeder conveyor 233 (of the output transfer station 210b) to advance that storage device 600 into a pick-up position in which the storage device 600 extends outwardly from the first slot 214b, thereby allowing the storage device 600 to be retrieved, e.g., by an operator. After the storage device 600 is removed from the output transfer station 210b by the operator, the control electronics 232 (of the output transfer station 210b) will detect that the first slot 214b is empty, and, in response, will move the next storage device 600 into alignment with the first slot 214b via movement of the conveyor assembly 220 of the output transfer station 210b and then out of the conveyor assembly 220 (of the output transfer station 210b) and into the pick-up position in the first slot 214b. This process can be repeated for each subsequent storage device 600 stored in the output transfer station 210b.

The status of the conveyor assembly 220 of the output transfer station 210b is monitored by the control electronics 232 (of the output transfer station 210b), which control the status indicator light 218b. The status indicator light 218b on the output transfer station 210b will light up (e.g., illuminate a green light) when the conveyor assembly 220 (of the output transfer station 210b) is fully stocked with tested storage devices 600 and is ready to be emptied. When the conveyor assembly 220 (of the output transfer station 210b) is emptied of the tested storage devices 600, the status indicator light 218b will turn off (or provide a light of a different color).

The respective control electronics 232 of the input and output transfer stations 210a, 210b can be placed in communication with the controller 130 so that the robot 300 can be controlled based on the status of the input and output transfer stations 210a, 210b.

### Other Embodiments

While certain embodiments have been described above, other embodiments are possible.

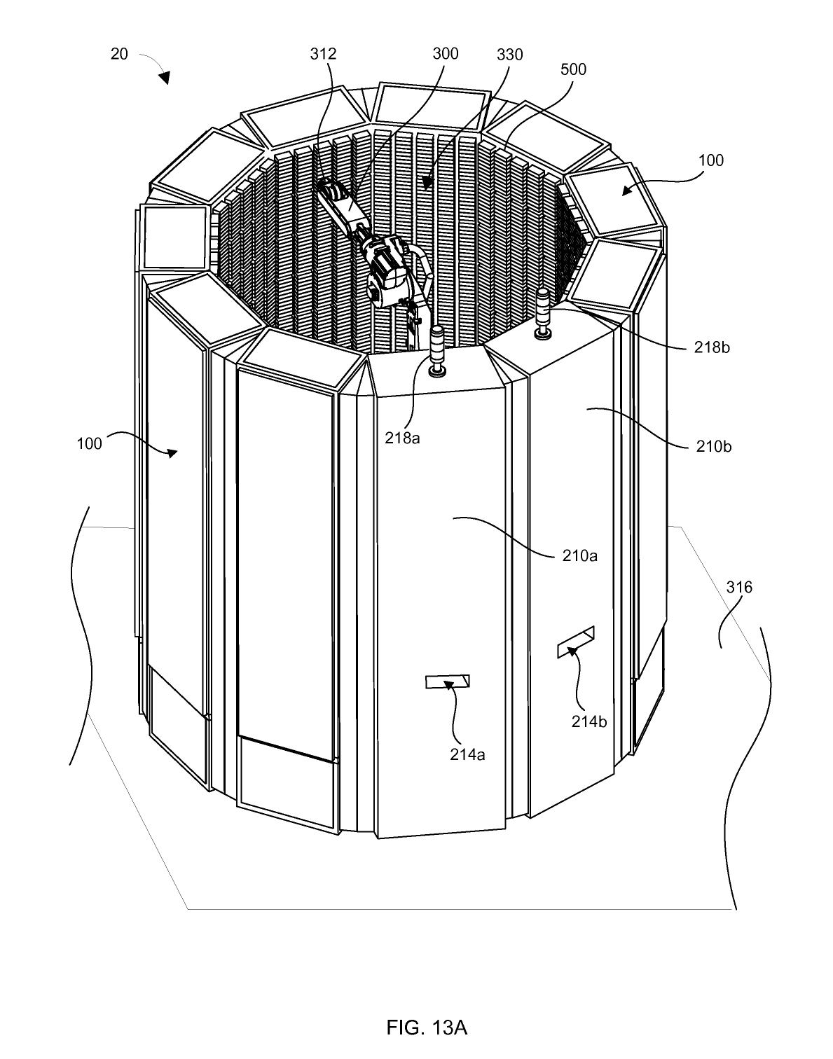

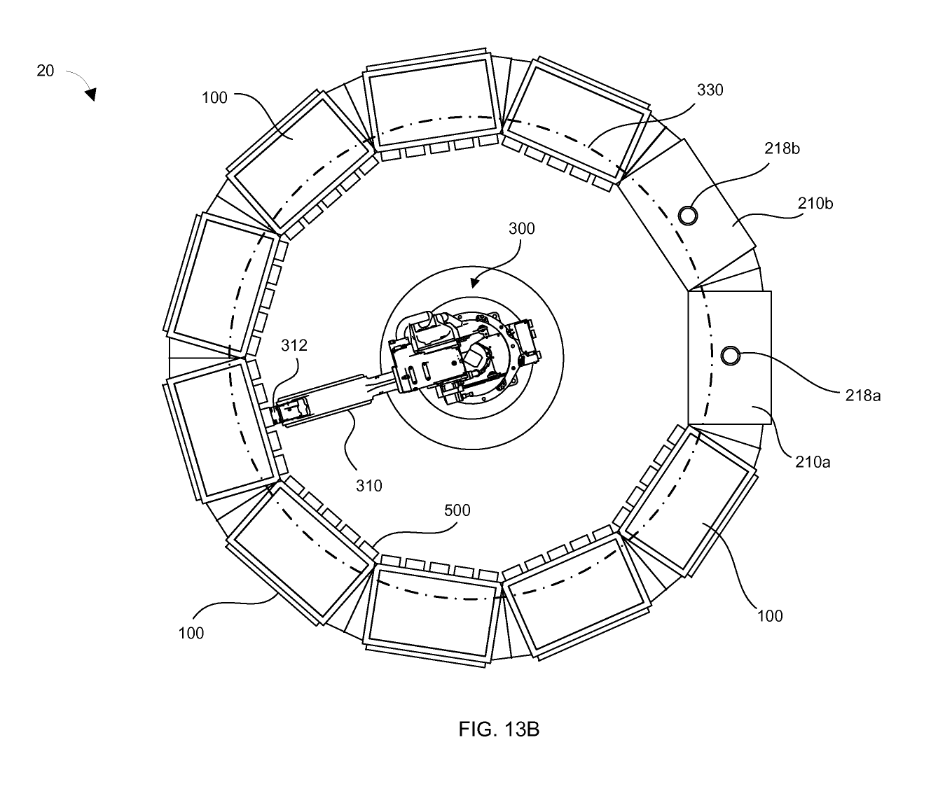

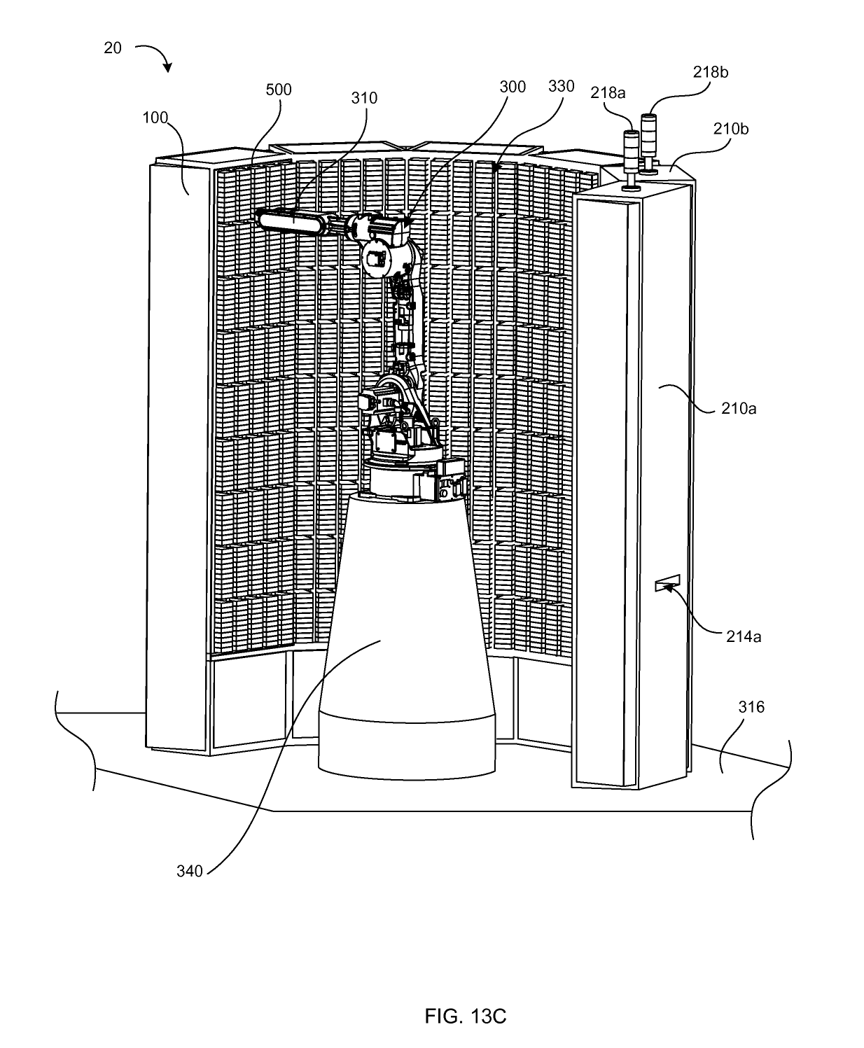

For example, FIGS. 13A-13C illustrate an embodiment of a storage device testing system 20 in which the test racks 100 and the input and output transfer stations 210a, 210b are arranged in a circular array about the robot 300. The robot 300 defines a substantially cylindrical working envelope volume 330, with the test racks 100 and the transfer stations 210a, 210b being arranged within the working envelope 330 for accessibility of each test slot 500 for servicing by the robot 300. The substantially cylindrical working envelope volume 330 provides a compact footprint and is generally only limited in capacity by height constraints. In some examples, the robot 300 is elevated by and supported on a pedestal or lift 340 (FIG. 13C) on the floor surface 316. The pedestal or lift 340 increases the size of the working envelope volume 330 by allowing the robot 300 to reach not only upwardly, but also downwardly to service test slots 500 and/or the transfer stations 210a, 210b. The size of the working envelope volume 330 can be further increased by adding a vertical actuator to the pedestal or lift 340.

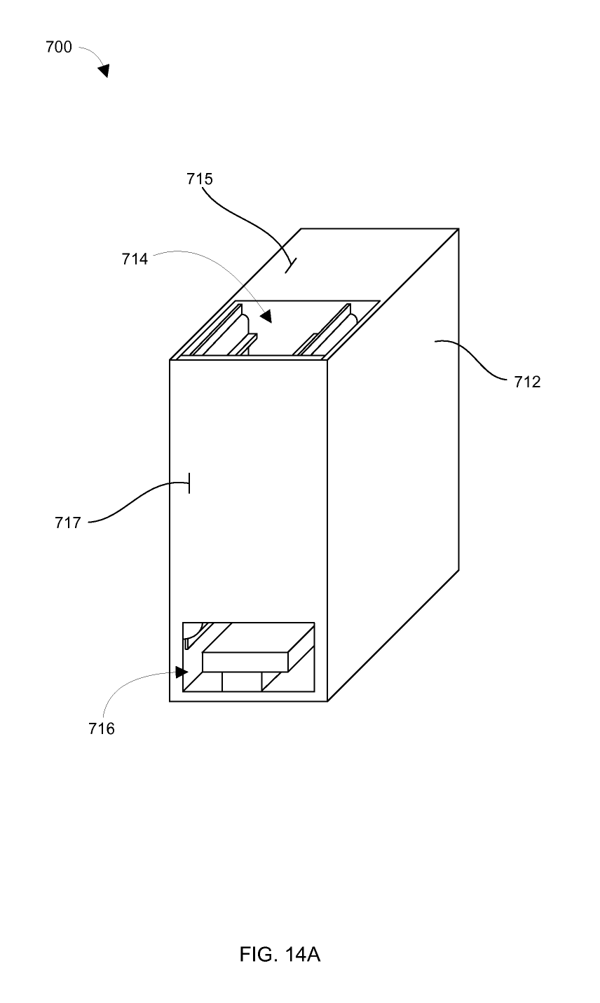

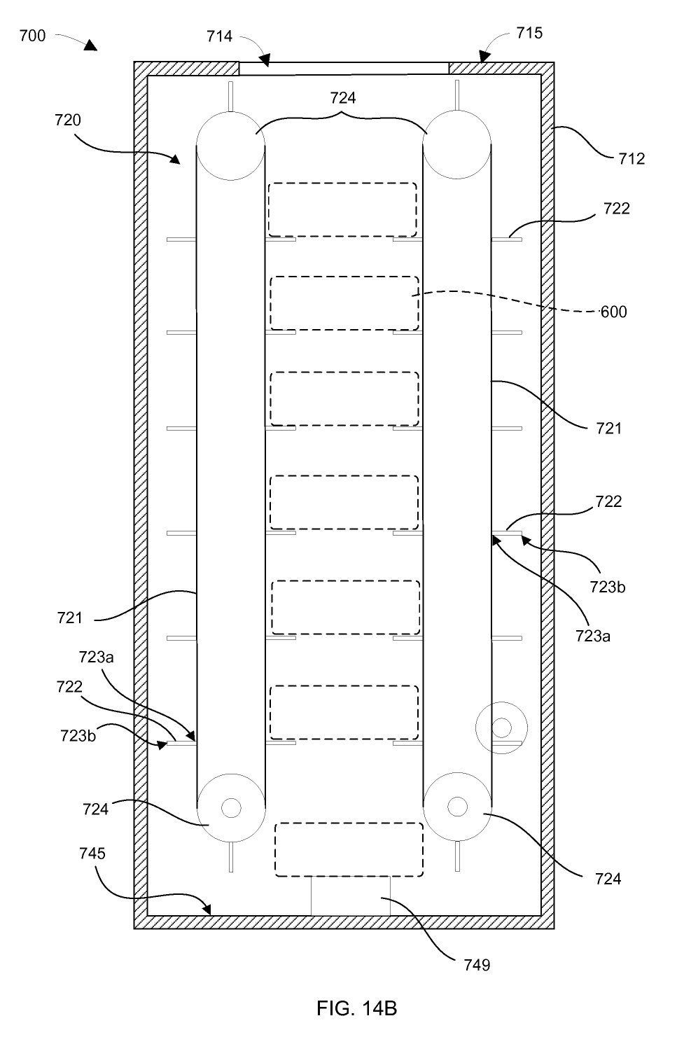

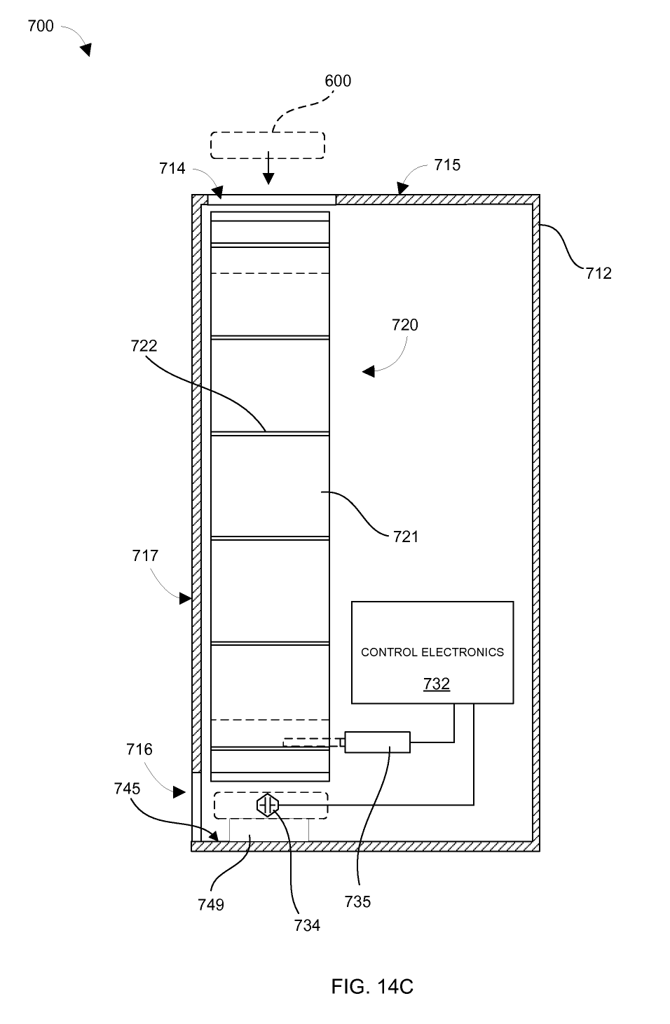

FIGS. 14A-14C illustrate another embodiment of an transfer station 700. The transfer station 700 includes a housing 712 (e.g., a sheet metal enclosure) with a first slot 714 disposed along a top surface 715 of the housing 712. The first slot 714 functions as an interface between an operator and the transfer station 700. A second slot 716 is disposed along a second surface 717 of the housing 712. The second slot 716 functions as an interface between the robot 300 and the transfer station 700. Disposed within the housing is a conveyor assembly 720. The conveyor assembly 720 receives and stores storage devices 600, such as disk drives, and operates to convey the storage devices 600 between the first and second slots 714, 716.

As shown in FIGS. 14B and 14C, the conveyor assembly 720 includes a parallel pair of continuous loops 721 and a plurality of supports 722. Each of the supports 722 includes a first end 723a that is connected to, or integrally formed with, a corresponding one of the loops 721, and a second end 723b that extends outwardly from the associated loop 721 in a cantilever fashion. The supports 722 are arranged in pairs such that each pair of the supports 722 can receive and support a storage device 600 between the loops 721. Consecutive pairs of the supports 722 are spaced apart from each other along a length of the loops 721 such that a plurality of storage devices 600 can be supported and maintained in spaced relation to each other along a length of the loops 721. The loops 721 can be belts (e.g., plastic or rubber belts), wire mesh, or chains. The supports 722 can be formed from metal (e.g., sheet metal), or plastic and can be connected to the loops 721, e.g., via adhesive, welds, or hardware (e.g., screws) or integrally formed (e.g., molded) therewith.

The loops 721 are mounted on rotatable spindles 724, which allow the loops 721 to rotate and thereby convey the storage devices 600 between locations along the length of the loops 721. The loops 721 can rotate under gravity, e.g., under the weight of the storage devices, to deliver the storage devices 600 from the first slot 714 to the second slot 716.

The first slot 714 provides access into the housing 712, thereby allowing an operator to introduce storage devices 600, e.g., one at a time, into the conveyor assembly 720.

The second slot 716 includes a pedestal 749. The pedestal 749 is dimensioned to hold the storage device 600 in an elevated position above a lower surface 745 of the second slot 716. Storage devices 600 fed into the transfer station 700, e.g., by an operator, at the first slot 714 are delivered, e.g., one at a time, to the pedestal 749, via rotation of the loops 721, where they can be retrieved by the robot 300. The width of the pedestal 749 allows the sidewalls 418 of the storage device transporter 400 to fit around the pedestal 749 such that the storage device transporter 400 can be positioned underneath a storage device supported on the pedestal 749, and such that the pedestal 749 is accommodated in the U-shaped opening 415 of the storage device transporter 400.

A detector 734 (e.g., an optical sensor or switch) is associated with the second slot 716 for detecting the presence of a storage device on the pedestal 749. The detector 734 is in communication with control electronics 732, which monitor the status of the second slot 716 based on signals received from the detector 734.

The transfer station 700 can also include an actuator 735 (e.g., a solenoid) in communication with the control electronics 732. The actuator 735, under the control of the control electronics 732, can be arranged to engage the conveyor assembly 720 to inhibit movement of the loops 721. For example, the actuator 735 can be arranged to interfere with the support 722 to inhibit (e.g., prevent) further rotation of the loops 721.

When the control electronics 732 determine that a storage device 600 is positioned on the pedestal 749, awaiting to be retrieved by the robot 300, the control electronics 732 can actuate the actuator 735 to inhibit further movement of the conveyor assembly 720 until the storage device 600 has been removed from the pedestal 749 and the pedestal 749 is again ready to accept another storage device 600.

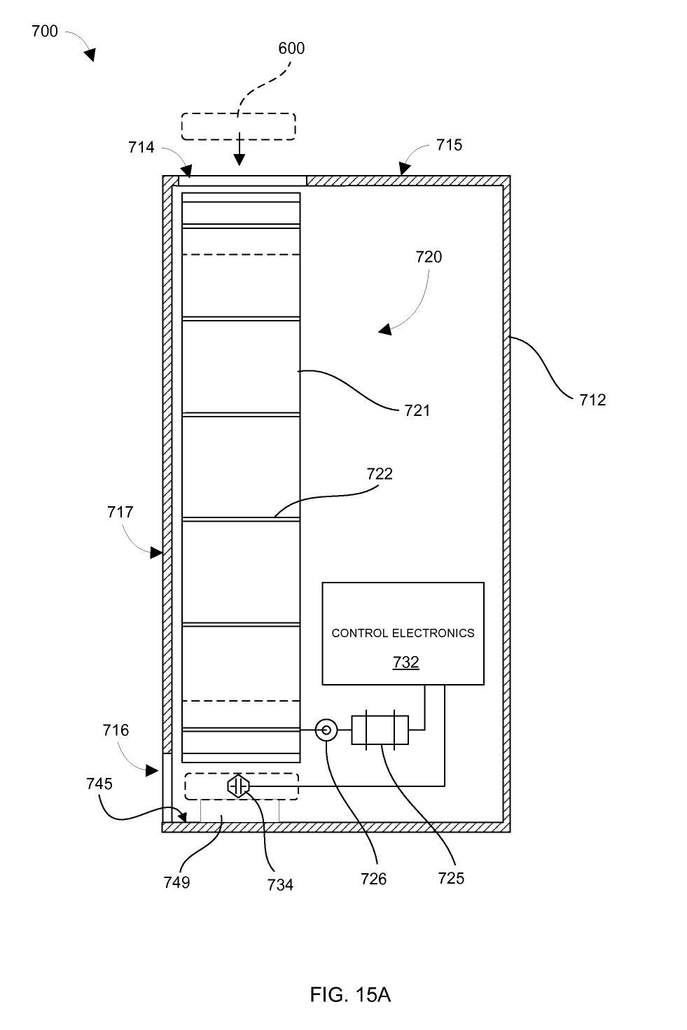

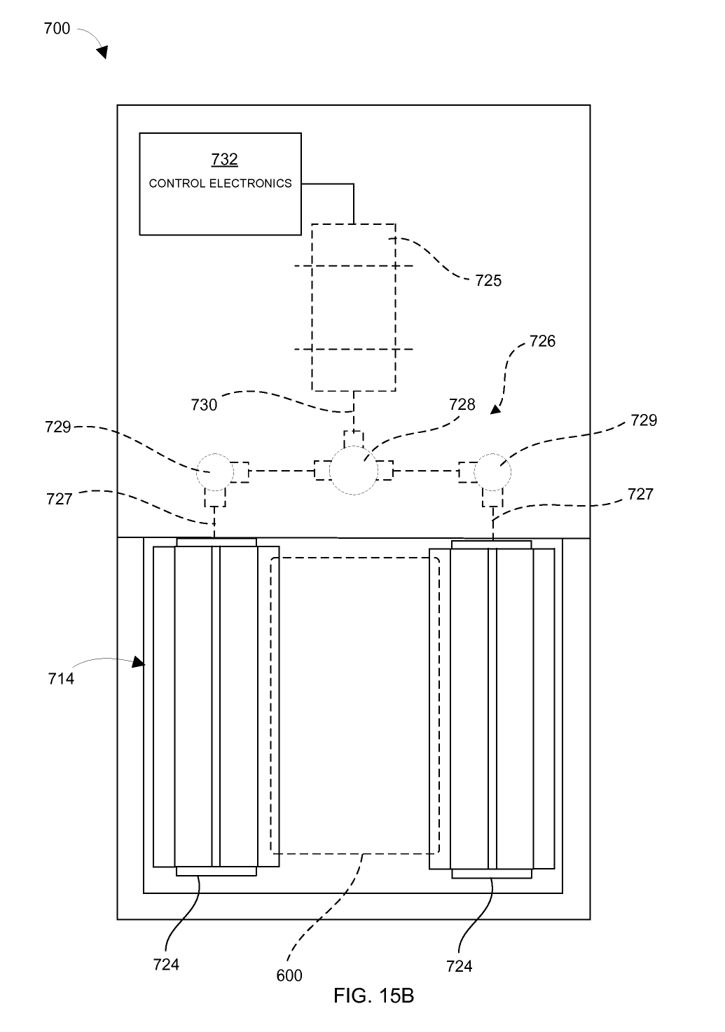

Alternatively or additionally, the transfer station 700 can include an electric motor drivably connected to the conveyor assembly 720 for controlling movements of the loops 721. For example, FIGS. 15A and 15B illustrate an embodiment of a transfer station 700′ in which an electric motor 725 is drivably connected to a pair of the spindles 724 of the conveyor assembly 720 via a drive train 726 (FIG. 15B). The drive train 726 includes a pair of drive shafts 727, each connected to an associated one of the spindles 724, and a differential 728. On the output side, the differential 728 is drivably connected to each of the drive shafts 727 via right angle gears 729. On the input side, the differential 728 is drivably connected to a shaft 730 of the electric motor 725. Rotation of the motor shaft 730 drives the spindles 724 through the drive train 726. The motor 725 is electrically connected to control electronics 732 which control operation of the motor 725.

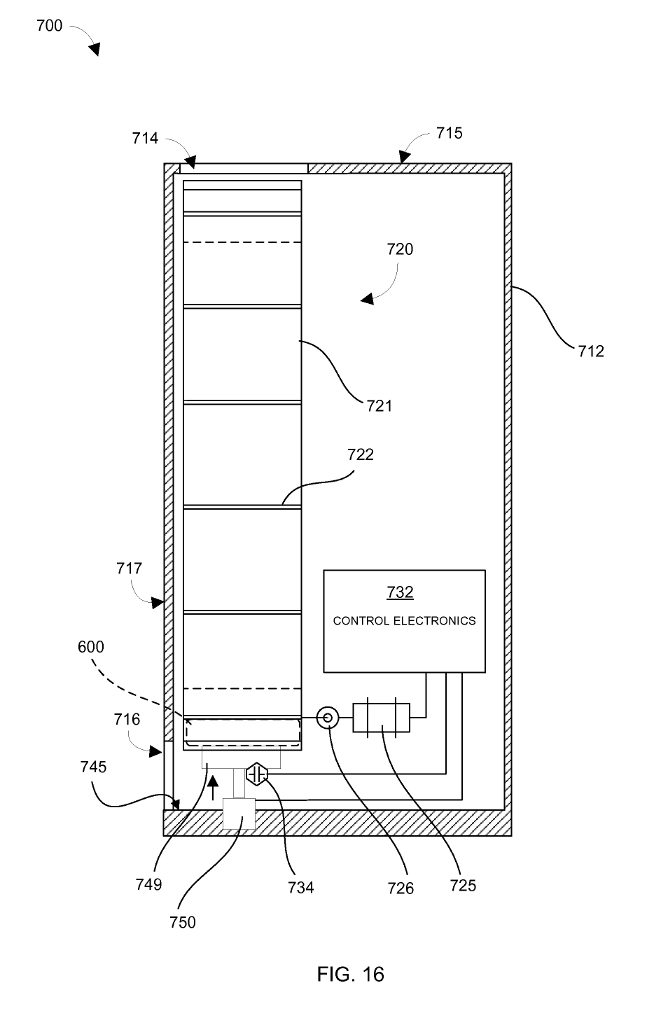

In some embodiments, the pedestal 749 may also be capable of being elevated to help introduce storage devices 600 into the conveyor assembly 720 from the second slot 716. For example, FIG. 16 illustrates an embodiment of a transfer station 700″ in which the pedestal 749 is mounted on a linear actuator 750 that is controlled by the control electronics 732. This can allow the transfer station 700″ to be used as an output transfer station. For example, the robot 300 can deliver a storage device to the pedestal 749. Then, under the control of the control electronics 732, the linear actuator 750 can be actuated to elevate the pedestal 749 such that the storage device 600 is positioned to be received between the loops 721. In this case, the electric motor 725 can be driven to deliver the storage device 600 from the pedestal 749 toward the first slot 714, where it can be retrieved, e.g., by an operator.

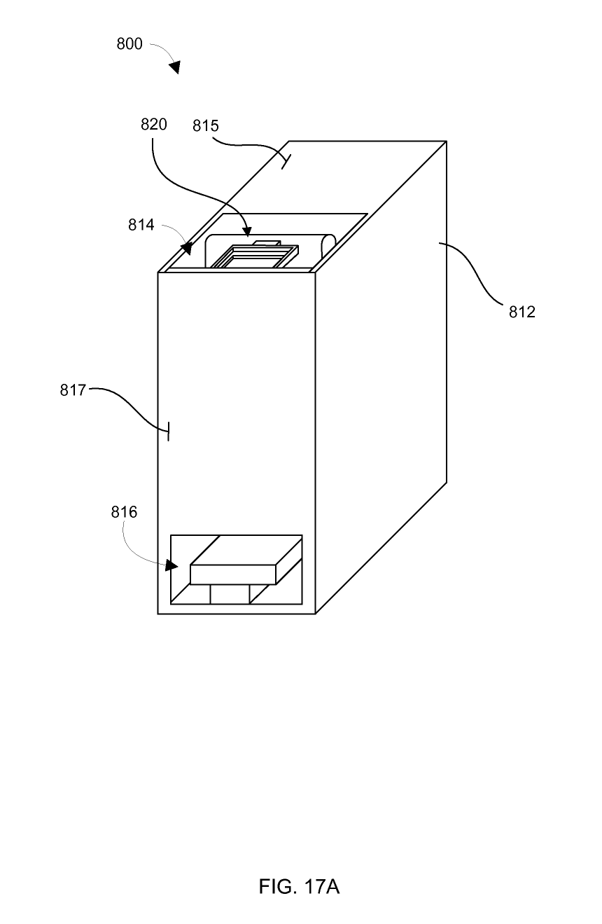

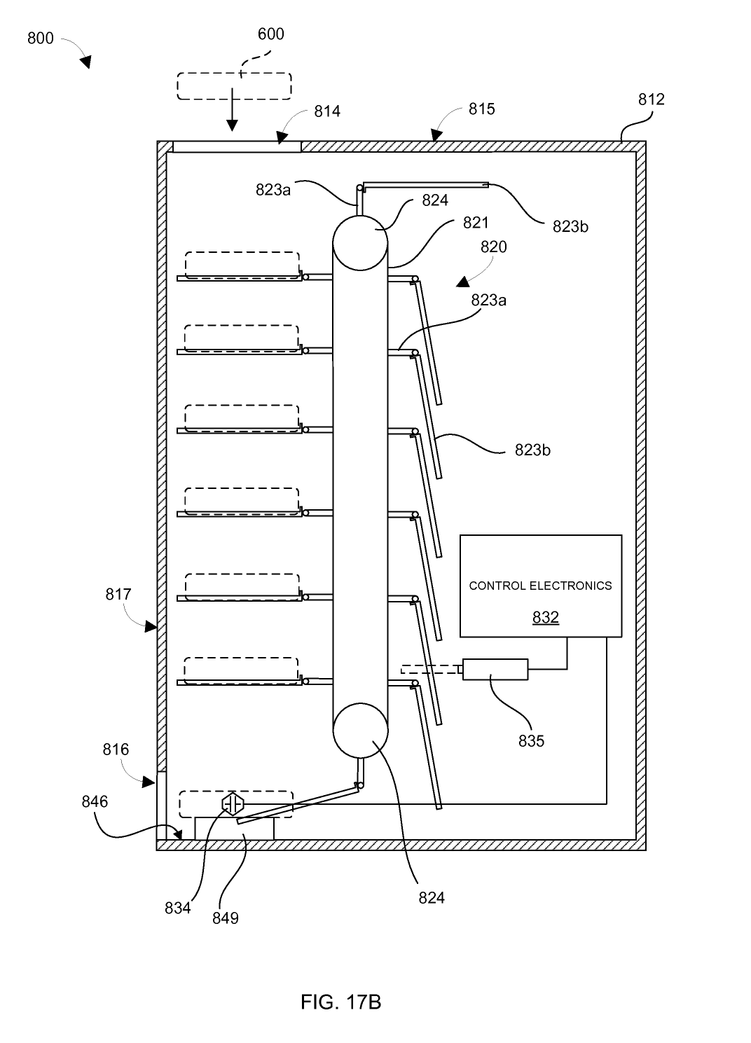

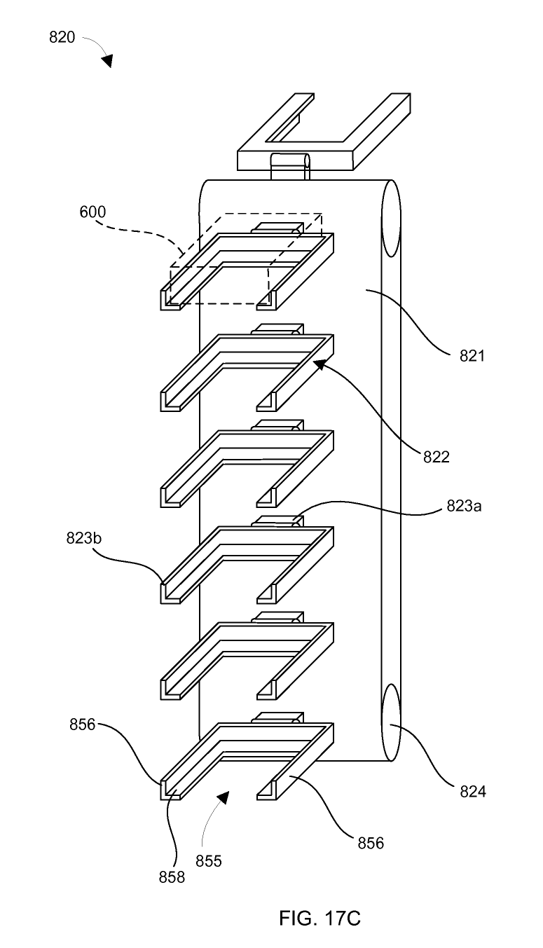

FIGS. 17A-17C illustrate another embodiment of a transfer station 800. The transfer station 800 includes a housing 812 (e.g., a sheet metal enclosure) with a first slot 814 disposed along a top surface 815 of the housing 812. The first slot 814 functions as an interface between an operator and the transfer station 800. A second slot 816 is disposed along a second surface 817 of the housing 812. The second slot 816 functions as an interface between the robot 300 and the transfer station 800. Disposed within the housing 812 is a conveyor assembly 820. The conveyor assembly 820 receives and stores storage devices 600, such as disk drives, and operates to convey the storage devices 600 between the first and second slots 814, 816.

As shown in FIGS. 17B and 17C, the conveyor assembly 820 includes a continuous loop 821 and a plurality of hinged platforms 822. Each of the platforms 822 includes a first portion 823a that is connected to the loop 821, and a second portion 823b that is pivotally connected to the first portion 823a. The second portion 823b of the platforms 822 has a shape that similar to the storage device transporter 400, including a substantially U-shaped opening 855 that is formed by sidewalls 856 and a base plate 858 that support a storage device 600 as it is conveyed between the first slot 814 and the second slot 816.

The loop 821 can be a belt (e.g., plastic or rubber belt). The platforms 822 can be formed from metal (e.g., sheet metal), or plastic and can be connected to the loop 821, e.g., via adhesive, welds, or hardware (e.g., screws).

The loop 821 is mounted on rotatable spindles 824, which allow the loop 821 to rotate and thereby convey the storage devices 600 between the first and second slots 814, 816. The loop 821 can rotate under gravity, e.g., under the weight of the storage devices, to deliver the storage devices 600 from the first slot 814 to the second slot 816.

The first slot 814 provides access into the housing 812, thereby allowing an operator to introduce storage devices 600, e.g., one at a time, into the conveyor assembly 820. The second slot 816 includes a pedestal 849. The pedestal 849 is dimensioned to hold the storage device 600 in an elevated position above a lower surface 845 of the second slot 816. Storage devices 600 fed into the transfer station 800, e.g., by an operator, at the first slot 814 are delivered, e.g., one at a time, to the pedestal 849, under gravity, e.g., via rotation of the loop 821, where they can be retrieved by the robot 300. The width of the pedestal 849 allows the sidewalls 418 of the storage device transporter 400 to fit around the pedestal 849 such that the storage device transporter 400 can be positioned underneath a storage device 600 supported on the pedestal 849, and such that the pedestal 849 is accommodated in the U-shaped opening 415 of the storage device transporter 400.

A detector 834 (e.g., an optical sensor or switch) is associated with the second slot 816 for detecting the presence of a storage device 600 on the pedestal 849. The detector 834 is in communication with control electronics 832, which monitor the status of the second slot 816 based on signals received from the detector 834.

The transfer station 800 can also include an actuator 835 (e.g., a solenoid) in communication with the control electronics 832. The actuator 835, under the control of the control electronics 832, can be arranged to engage the conveyor assembly 820 to inhibit movement of the loop 821. For example, the actuator 835 can be arranged to interfere with the platforms 822 to inhibit (e.g., prevent) further movement of the loop 821.

When the control electronics 832 determine, e.g., based on signals received from the detector 834, that a storage device 600 is positioned on the pedestal 849, awaiting to be retrieved by the robot 300, the control electronics 832 can actuate the actuator 835 to inhibit further movement of the conveyor assembly 820 until the storage device 600 has been removed from the pedestal 849 and the pedestal 849 is again ready to accept another storage device 600.

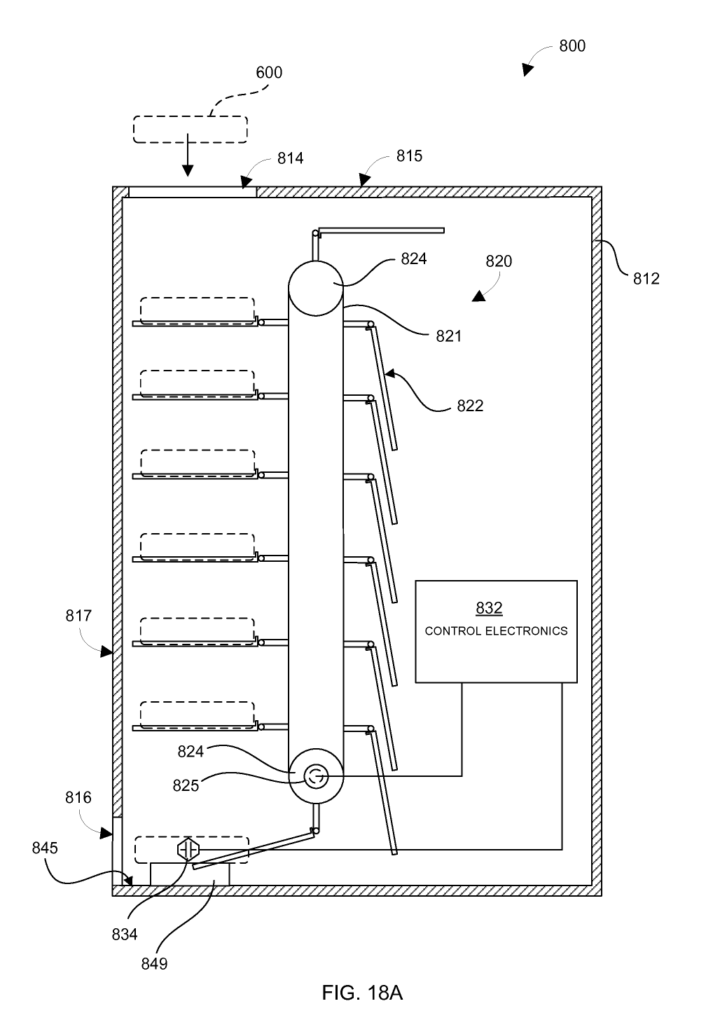

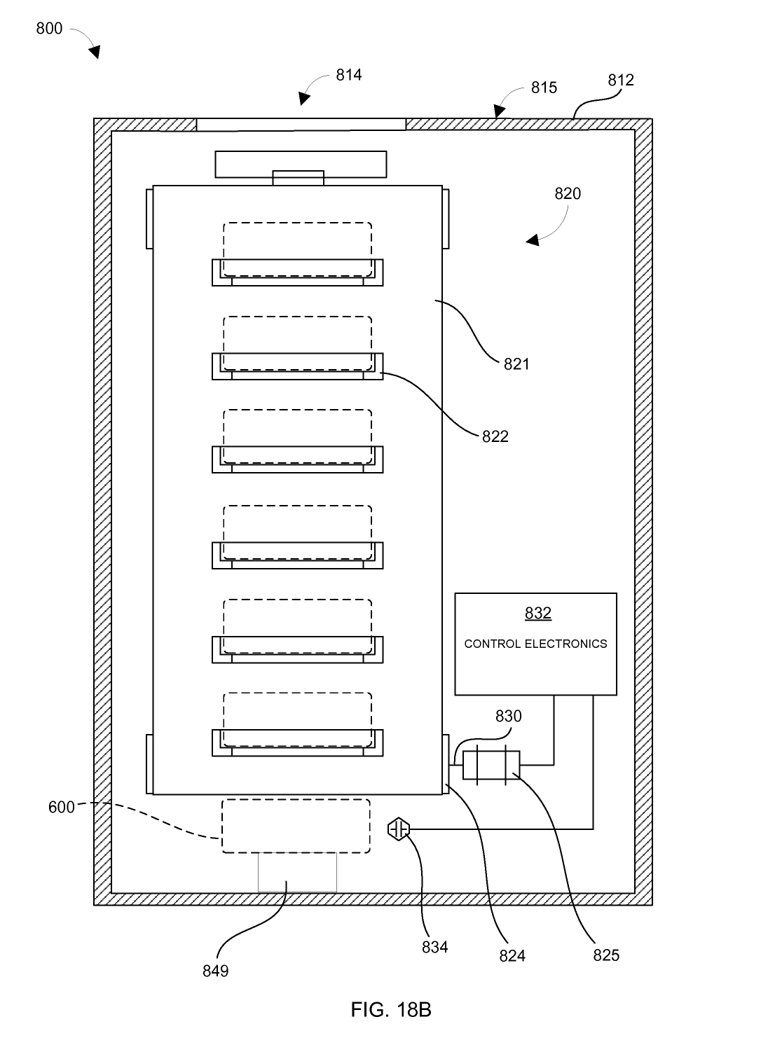

Alternatively or additionally, the transfer station 800 can include an electric motor drivably connected to the conveyor assembly 820 for controlling movements of the loop 821. For example, FIGS. 18A and 18B illustrate an embodiment of a transfer station 800′ an electric motor 825 is drivably connected to one of the spindles 824 of the conveyor assembly 820. Rotation of the motor shaft 830 drives the spindle 824. The motor 825 is electrically connected to control electronics 832 which control operation of the motor 825.

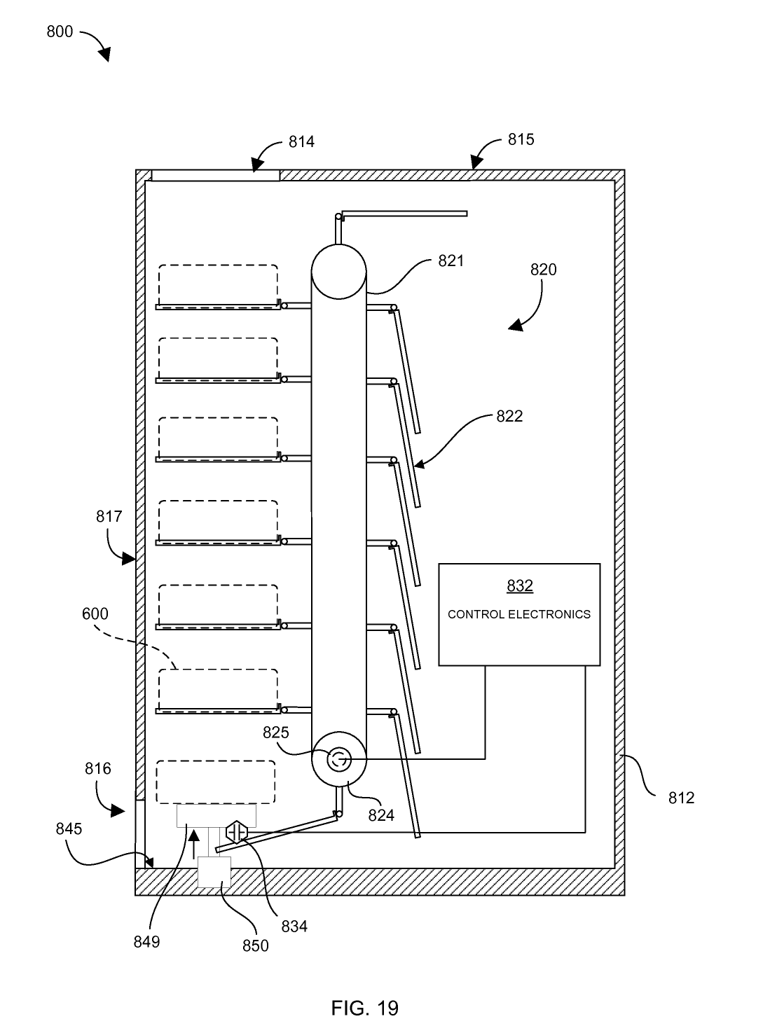

In some embodiments, the pedestal 849 may also be capable of being elevated to help introduce storage devices 600 into the conveyor assembly 820 from the second slot 816. For example, FIG. 19 illustrates an embodiment of a transfer station 800″ in which the pedestal 849 is mounted on a linear actuator 850 that is controlled by the control electronics 832. This can allow the transfer station 800″ to be used as an output transfer station. For example, the robot 300 can deliver a storage device to the pedestal 849. Then, under the control of the control electronics 832, the linear actuator 850 can be actuated to elevate the pedestal 849 such that the storage device 600 is positioned to be received between the sidewalls 856 (FIG. 17C) of one of the platforms 822. In this case, the electric motor 825 can be driven to deliver the storage device 600 from the pedestal 489 toward the first slot 814, where it can be retrieved, e.g., by an operator.

In some embodiments, a storage device testing system can include multiple input transfer stations and/or multiple output transfer stations.

In some cases, the transfer station can be configured to receive storage devices supported in storage device transporters, such that each of the storage devices storage devices is presented together with one of the storage device transporters for servicing, e.g., by a robot.

Other embodiments are within the scope of the following claims.

What is claimed is:

1. A storage device transfer station, comprising:
a first slot;
a second slot; and
a conveyor assembly configured to receive and support a plurality of storage devices such that the storage devices are vertically stacked and in spaced relation to each other, the conveyor assembly being operable to convey the storage devices between the first slot and the second slot.

2. The storage device transfer station of claim 1, wherein the conveyor assembly comprises a pair of continuous loops arranged to receive a plurality of storage devices therebetween.

3. The storage device transfer station of claim 2, wherein the continuous loops comprise belts, wire mesh, or chains.

4. The storage device transfer station of claim 1, wherein the conveyor assembly comprises:
a continuous loop, and
a plurality of platforms extending outwardly from the continuous loop, each of the plurality of platforms being configured to receive and support a storage device.

5. The storage device transfer station of claim 4, wherein each of the plurality of platforms comprises:
a first portion connected to the continuous loop; and
a second portion pivotally connected to the first portion.

6. The storage device transfer station of claim 1, further comprising an actuator, wherein the actuator is arranged to advance a storage device at least partially out of the conveyor assembly and at least partially into the second slot.

7. The storage device transfer station of claim 1, further comprising a feeder conveyor, wherein the feeder conveyor is arranged to assist in moving a storage device through the first slot.

8. The storage device transfer station of claim 1, further comprising:
a detector arranged to detect the presence of a storage device within the second slot; and
control electronics in communication with the sensor,
wherein the control electronics are configured to control movement of the conveyor assembly based, at least in part, on signals received from the detector.

9. The storage device transfer station of claim 1, wherein the conveyor assembly is operable to convey the storage devices between the first slot and the second slot under gravity.

10. The storage device transfer station of claim 1, further comprising:
an electric motor drivably connected to the conveyor assembly; and
control electronics in communication with the electric motor, wherein the control electronics are configured to control movements of the conveyor assembly via the electric motor.

11. A storage device testing system comprising:
one or more test racks;
a plurality of test slots supported by the test racks, each of the plurality of test slots being configured to receive a storage device for testing;
a storage device transfer station; and
automated machinery configured to transfer storage devices between the storage device transfer station and the plurality of test slots,
wherein the storage device transfer station comprises:
(i) a first slot;
(ii) a second slot; and
(iii) a conveyor assembly configured to receive and support a plurality of storage devices such that the storage devices are vertically stacked and in spaced relation to each other, and the conveyor assembly being operable to convey the storage devices between the first slot and the second slot.

12. The storage device testing system of claim 11, wherein the first slot is configured to receive storage devices from an operator.

13. The storage device testing system of claim 11, wherein the first slot is configured to receive storage devices, one at a time, from an operator.

14. The storage device testing system of claim 11, wherein the second slot is configured to present storage devices for servicing by the automated machinery.

15. The storage device testing system of claim 11, wherein the second slot is configured to present storage devices, one at a time, for servicing by the automated machinery.

16. The storage device testing system of claim 11, wherein the second slot is configured to receive storage devices from the automated machinery, and wherein the first slot is configured to present storage devices for retrieval by an operator.

17. The storage device testing system of claim 11, wherein the second slot is configured to receive storage devices, one at a time, from the automated machinery, and wherein the first slot is configured to present storage devices, one at a time, for retrieval by an operator.

18. A storage device testing system comprising:
one or more test racks;
a plurality of test slots supported by the test racks, each of the plurality of test slots being configured to receive a storage device for testing;
an input/output station; and
automated machinery configured to transfer storage devices between the input/output station and the plurality of test slots,
wherein the input/output station comprises:
an input transfer station configured:
(i) to receive storage devices,
(ii) to stock the received storage devices in spaced relation to each other, and
(iii) to present the storage devices for servicing by the automated machinery; and
an output transfer station configured to receive tested storage devices from the automated machinery, stock the tested storage devices in spaced relation to each other, and present the tested storage devices for retrieval.

19. The storage device testing system of claim 18, wherein the input transfer station is configured to receive storage devices directly from an operator.

20. The storage device testing system of claim 18, wherein the input transfer station is configured to receive storage devices, one at a time, directly from an operator.

21. The storage device testing system of claim 18, wherein the output transfer station is configured to present tested storage devices for retrieval by an operator.

22. The storage device testing system of claim 18, wherein the output transfer station is configured to present tested storage devices, one at a time, for retrieval by an operator.

23. A method of supplying storage devices to a storage device testing system, the method comprising:
manually loading a plurality of storage devices into a storage device transfer station;
actuating automated machinery to retrieve one storage device of the plurality of storage devices from the storage device transfer station; and
actuating the automated machinery to deliver the one storage device to a test slot of the storage device testing system and insert the one storage device in the test slot,
wherein the storage device transfer station is configured to receive and support the plurality of storage devices such that the plurality of storage devices are maintained in spaced relation to each other.

24. The method of claim 23, wherein manually loading the plurality of storage devices comprises loading the storage devices one at a time into the storage device transfer station.

25. The method claim 23, wherein manually loading the plurality of storage devices comprises feeding the plurality of storage devices into the storage device transfer station through a first slot of the transfer station.

26. The method claim 23, wherein the storage device transfer station is configured to receive and support the plurality of storage devices such that the plurality of storage devices are vertically stacked and in spaced relation to each other.

27. A storage device transfer station, comprising:
a first slot, and
a second slot; and
a conveyor assembly configured to receive and support a plurality of storage devices such the plurality of storage devices are maintained in spaced relation to each other,
wherein the conveyor assembly is configured to deliver the plurality of storage devices between the first slot and the second slot under gravity.
